(19) United States
(12) Patent Application Publication
(10) Pub. No.: US 2021/0405836 A1
(43) Pub. Date: Dec. 30, 2021

(54) SPLICE AND PATCH PANEL GUI FOR CABLE LAYOUT AND DESIGN

(71) Applicant: IQGeo America Inc., Denver, CO (US)

(72) Inventor: Randall S. Anderson, South Jordan, UT (US)

(21) Appl. No.: 17/343,356

(22) Filed: Jun. 9, 2021

Related U.S. Application Data
(60) Provisional application No. 63/036,690, filed on Jun. 9, 2020.

(51) Int. Cl. G06F 3/0484; G06F 3/0482

(52) U.S. Cl. CPC G06F 3/0484; G06F 3/0482

(57) ABSTRACT

The present invention is a system and method for automating several processes that are presently time-consuming and labor intensive projects, and more specifically, the invention is a system and method implemented by a computer-based tool that enables a user to bring multiple cables (202) together and illustrate in a graphical manner the splices between individual fibers (206) in multiple tubes (204) within multiple cables (202). In addition, user may dynamically move one of more cables (202) in the schematic diagram (200) and the tool will automatically redraw all of the splices between fibers (202) in a manner that creates an efficient layout of the splices. The schematic diagram (200) may show different levels of detail and thereby hide specific splices between fibers (206) until they are needed.

### CROSS-REFERENCE TO RELATED APPLICATION

This application claims priority to U.S. Provisional Patent Application No. 63/036,690 entitled “SPLICE AND PATCH PANEL GUI FOR CABLE LAYOUT AND DESIGN” filed Jun. 9, 2020. The contents of the above-noted provisional application is incorporated herein as if set forth in full and priority to this application is claimed to the full extent allowable under U.S. law and regulations.

### BACKGROUND

### Field of the Invention

This invention relates generally to a computer-based tool for automated layout and modification of connections between optical elements of a fiber optic network. More specifically, the invention relates to a system and method for automating the illustration of connections between individual optical elements and enabling modifications of those connections.

### Description of Related Art

The tracking of connections between fiber optic cables and the fiber optic tubes and optical fibers within the cables is critically important in fiber optic network management. The number of cables that are used to carry data has grown exponentially as the transmission of information has become critical to the global economy and infrastructure.

However, the ability to keep track of all the cables, the tubes, the fibers and the interconnections or splices between fibers has also become exponentially more difficult.

Various computer-based tools have been developed to assist users in tracking connections between cables, tubes, and their fibers. However, these programs have had limited success because they are cumbersome to use and do not provide an easy way to illustrate connections. The problem of illustration connections through schematic diagrams is also exacerbated when connections are changed, thus rendering the existing schematic diagrams obsolete.

Furthermore, updating existing schematic diagrams has been a laborious and time-consuming task that existing tools have failed to make less cumbersome.

Finally, adding, subtracting, or moving entire cables from the schematic diagrams is equally time consuming and labor intensive.

Accordingly, it would be an advantage over the prior art to provide a computer-based tool that enables a user to illustrate in a schematic diagram the splices between cables, tubes, and fibers. It would be a further advantage if the cables could be dynamically moved in the schematic diagram and have all the splices between fibers automatically be redrawn to reflect the new relative positions of cables within the schematic diagram. It would be a further advantage to get exploded detailed views of splices between fibers by selective movement of a cursor over different locations within the schematic diagram.

It would be another advantage over the prior art if such schematic diagrams could be generated for a plurality of patch panels to thereby illustrate all of the interconnections between specific ports on the patch panels as well as for fiber optic networks distributed over a large geographic area.

### BRIEF SUMMARY

The present invention is directed to a system and method for managing fiber optic networks, including defining, modifying, and visualizing a network topology and connections between fiber optic elements. A computer-based tool is provided for automating several processes that are presently time-consuming and labor intensive projects, and more specifically, for enabling a user to view and illustrate in a graphical manner the splices between individual fibers in multiple tubes within multiple cables. Moreover, a user may dynamically move one or more optical elements in the schematic diagram and the computer-based tool will automatically redraw and store all of the splices between fibers in a manner that creates an efficient layout of the splices. The schematic diagram may show different levels of detail and thereby hide specific splices between fibers until needed and allows a user to easily drill down to show greater levels of detail in the schematic diagram as needed. In this manner, the invention facilitates effective visualization and management of fiber networks.

In accordance with one aspect of the present invention, a system and associated functionality is provided for defining, modifying, and visualizing connections between optical elements in a fiber-optic network. An associated process involves establishing a computer-based visualization tool for visualizing a fiber-optic network comprised of fiber-optic elements. The fiber-optic elements include multiple fiber-optic cables, wherein at least some of the fiber-optic cables include multiple fiber-optic tubes and at least some of the fiber-optic tubes include multiple optical fibers. The fiber-optic cables, fiber-optic tubes, and optical fibers each define a level of a fiber-optic hierarchy.

The process further involves operating the visualization tool to obtain configuration information concerning a configuration of the fiber-optic network. For example, a user may access an image or map of the fiber-optic network, or a portion thereof, to select a splice or connection point of interest. The visualization tool is then operative to generate a display showing the connections of the fiber-optic elements at the connection point based on the configuration information. For example, the display may show a number of cables that meet at the connection point as well as the fiber-optic tubes and optical fibers contained within each cable. The user can then operate a user interface device, such as a touchscreen or mouse, in relation to the display to indicate a change in connections at the connection point. For example, the user may implement a drag-and-drop operation to indicate a desired connection between two optical fibers at the connection point. In response, the computer-based tool may automatically draw a connection between the fibers. Additionally or alternatively, the user may identify a connection to be deleted or broken. The computer-based tool may then store updates to the network configuration in a network information database to reflect the connection changes.

In accordance with another aspect of the present invention, a system and associated functionality is provided for defining, modifying, and visualizing network connections in relation to patch panels. An associated method involves establishing a computer based visualization tool for visualizing a fiber-optic network including at least first and second patch panels for making connections between fiber-optic elements. Each of the patch panels includes multiple ports for receiving terminals of fiber-optic elements. The method further involves entering, into the computer-based visualization tool, attribute information for the patch panels. Such attribute information may identify how many rows and columns of ports the patch panel includes and how many ports are provided at each port location in a column. Based on this information, the computer-based visualization tool can generate a display including at least first and second patch panels. A user interface device, such as a touchscreen or mouse, can then be operated in relation to the display to indicate a change in relation to connections involving at least one of the patch panels. For example, a drag-and-drop operation may be implemented to define a connection between two ports of the patch panels. The ports may be in the same panel or different panels. The computer-based tool is then operative to automatically draw a connection between the ports. Additionally or alternatively, a connection may be identified to be deleted or broken. The computer-based visualization tool is then operative to update network configuration information reflecting the change.

In accordance with a still further aspect of the present invention, a system and associated functionality is provided for defining, modifying, and visualizing connections of a fiber-optic network distributed over a geographic area. An associated method involves accessing an image or map of the fiber-optic network to identify a connection point of interest, e.g., a manhole. A user can then enter information defining a fiber-optic element at the connection point or to change connections at the connection point. To define a fiber-optic element, the user may enter, into the computer-based visualization tool, attribute information for the element. For example, the user may populate a table or enter via another user interface information defining superducts and included innerducts of a fiber-optic element at the connection point. To change connections, a user may employ a drag-and-drop operation to form a new connection or identify an existing connection to be deleted or broken. The computer-based visualization tool is then operative to generate a graphical representation of the new fiber-optic element(s) and the changes to connections at the connection point as well as to update information concerning the fiber-optic network in a network database. The resulting fiber-optic connections may be illustrated on a butterfly diagram superimposed on a geographic map of the network.

Thus, in accordance with one objective of the invention, a graphical overview may illustrate in a schematic diagram where cables are brought together, and connections are made between fibers in those cables.

In accordance with another objective of the invention, additional detail may be shown in the schematic diagram to show in an exploded view specific splices between specific fibers in the cables.

In accordance with a still further objective of the invention, the exploded view may be shown in a quickview by moving a cursor over a specific portion of the schematic diagram and causing a more detailed view of splices to be displayed, and then moving the cursor off the detailed view and thereby causing the detailed view to disappear.

In accordance with a further objective of the invention, the redrawing of the splices between fibers may be dynamically redrawn in order to allow the user to watch the movement of the splices.

In accordance with another objective of the invention, one or more cables may be added to a schematic drawing causing all of the existing cables to move and make room for the additional cable.

In accordance with a further objective of the invention, multiple patch panels may also be illustrated in a schematic diagram showing all path cables between ports, and wherein the software program shows a plurality of different views for paths followed by the patch cables between the same ports.

These and other embodiments of the present invention will become apparent to those skilled in the art from a consideration of the following detailed description taken in combination with the accompanying drawings.

### BRIEF DESCRIPTION OF THE SEVERAL VIEWS OF THE DRAWINGS

FIG. 1 is an illustration of a first embodiment of the invention wherein the cables are being brought together at a physical splicing enclosure.

FIGS. 2A-2B are illustrations of the first embodiment of the invention that illustrates a greater level of detail.

FIG. 3 is an illustration of the first embodiment of the invention that illustrates a Quickview feature.

FIGS. 4A-4B are illustrations of the first embodiment of the invention wherein the Quickview feature may be used to explode the detail within a Detail box.

FIG. 5 is an illustration that a Quickview of each Detail box and cable may also open and expand a Quickview.

FIGS. 6A-6B illustration of a splitter.

FIG. 7 is an illustration of the first embodiment of the invention and shows an expanded Quickview.

FIG. 8A shows the position before movement.

FIG. 8B shows the position after movement.

FIGS. 9A-9B show no connection before dragging.

FIG. 9c-9D show the connection after dragging.

FIGS. 10A-10B are illustrations that show that the first embodiment may also include a smoothing feature for the lines that are showing connections.

FIG. 11A shows the original labels given to the cables, tubes and fibers.

FIG. 11B shows the changed labels given to the cables, tubes and fibers.

FIG. 12A shows the original labels given to the tubes and fibers.

FIG. 12B shows the labels on the fibers toggled off.

FIG. 13 is an illustration of a patch panel that may be created using the second embodiment.

FIG. 14 is an illustration of the second embodiment that shows 2 patch panels.

FIG. 15A shows two patch panels and the interconnecting lines between ports.

FIG. 15B illustrates the ability to show more than two patch panels.

FIG. 16A shows two patch panels and indicates a port that needs to be connected from a first patch panel to a second patch panel.

FIG. 16B shows a line connecting the ports.

FIG. 17A shows the first patch panel. With some ports include some marking indicating that the port is being used.

FIG. 17B shows that the connected patch panel moves into view.

FIG. 18A shows a first representation of connecting cables between patch panels.

FIG. 18B shows a second representation of connecting cables between patch panels.

FIG. 18C shows a third representation of connecting cables between patch panels.

FIG. 18D shows a fourth representation of connecting cables between patch panels.

FIG. 19 is a bird's view diagram of a street map with a manhole cover and duct banks superimposed thereon.

FIG. 20 is a modified view of FIG. 19 which now shows graphics added to the Fig. that reveals the super ducts and inner ducts within each of the duct banks.

FIG. 21 is a view of the third embodiment of the invention. This Fig. is a butterfly drawing. The butterfly drawing lays out each wall of the manhole. In this figure, there are four walls so there are four walls shown relative to each other. Each of the walls shows the cross-section of the duct that enters the manhole, and the direction from which the ducts enter.

FIG. 22 is a drawing rendered by the third embodiment and is a display of the butterfly drawing that may be rendered automatically using a database of information. This view shows detail that may be displayed for each of the ducts that enters the manhole.

FIG. 23 is a table and a duct cross-section that is generated by the table. All of this data regarding the duct cross-section may be displayed by the third embodiment.

FIG. 24 is another bird's eye view of the street map of FIG. 20, but with added details. In this figure, the Cables and Splice Points in the manhole may be shown. Cabling, splices and slack have been added to this figure.

FIG. 25 shows what the cabling, splices and slack may look like in the butterfly diagram. Note that the specific fibers that are spliced together are shown.

FIG. 26 illustrates a screenshot of the computer-based tool. Specifically, it is noted that the butterfly diagrams may be displayed over a street map.

FIG. 27 shows that multiple windows may be pulled up on the display to show detail of each access point.

FIG. 28 is a schematic diagram of a system for defining, modifying, and visualizing a fiber optic network in accordance with the present invention.

FIG. 29 is a flow chart illustrating a process for defining, modifying, and visualizing connections between optical elements in a fiber optic network in accordance with the present invention.

FIG. 30 is a flow chart illustrating a process for defining, modifying, and visualizing patch panels and associated connections in accordance with the present invention.

FIG. 31 is a flow chart illustrating a process for defining, modifying, and visualizing connections formed at specified geographic locations (e.g., manholes) of a fiber optic network in accordance with the present invention.

### DETAILED DESCRIPTION

Reference will now be made to the drawings in which the various embodiments of the present invention will be discussed so as to enable one skilled in the art to make and use the invention. It is to be understood that the following description illustrates particular embodiments and implementations of the present invention for purposes of illustration and should not be viewed as narrowing the claims that follow.

In the following description, a system for managing fiber-optic networks is described in connection with a specific network implementation. Thereafter, three different embodiments or implementations of the invention are described in relation to: 1) visualizing and managing connections between fiber-optic elements including cables, tubes, and optical fibers; 2) visualizing and managing connections between fiber-optic elements at patch panels; and 3) visualizing and managing connections at connection points (e.g., manholes) of a geographically distributed fiber-optic network.

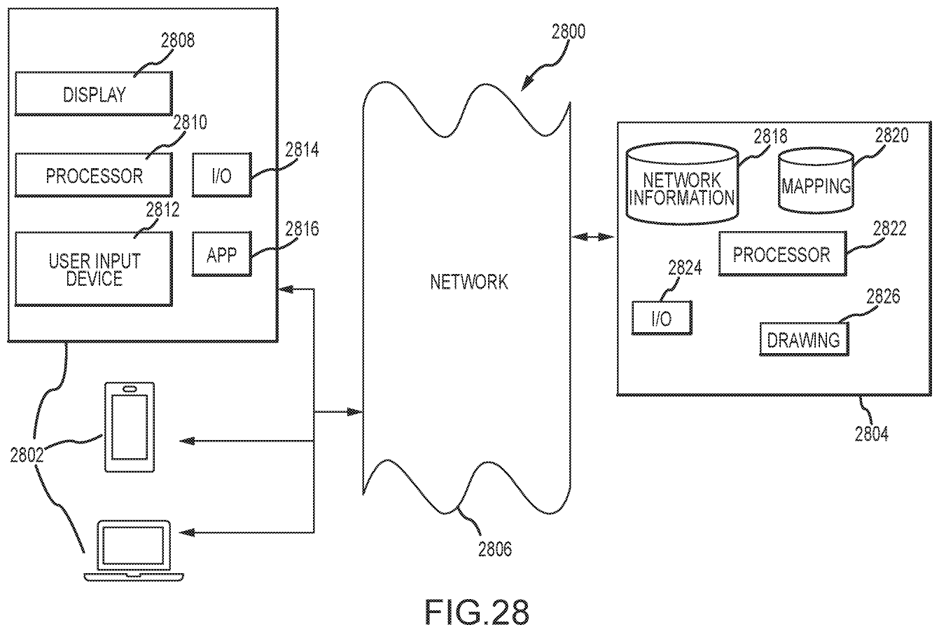

Referring to FIG. 28, a tool or system 2800 for use in managing a fiber-optic network is shown. As will be understood from description below, the system 2800 can be used to define, modify, and visualize connections in a fiber-optic network. FIG. 28 illustrates the system in a particular network environment where the functionality of the system 2800 is distributed between a user device and a separate platform. However, it will be appreciated that the functionality may be fully executed on a user device, may be distributed between a user device and the remote platform, or may be primarily executed on the remote platform. Such a platform may be accessed by the user device via a local area network or a wide area network, for example, the Internet. For example, the system 2800 may be a cloud-based system.

The illustrated system includes one or more user devices 2802 connected to a platform 2804 via a network 2806 such as a local area network or wide area network. Although the network 2806 is schematically illustrated as a single network, it will be appreciated that multiple network pathways including wireless network pathways, data network pathways, hotspots, and the like may be employed. The user devices 2802 may include data enabled telephones, tablets, laptops, desktop computers, or other data network devices.

Components of one of the user devices 2802 are illustrated schematically in FIG. 28. The user device 2802 generally includes a display 2808, a processor 2810, a user input device 2812, and input/output module 2814, and an application 2816 for executing certain functionality of the system 2800. As will be understood from the description below, the display 2808 is operative to display connections of the fiber-optic network and associated information as well as to enable various point-and-click and drag-and-drop operations. The processor 2810 receives user inputs and executes associated functionality, manages communications with the platform 2804, and performs various other functions.

The user input device 2012 may be, for example, a mouse, touchscreen, voice command module, or the like. In the embodiments described in detail below, the user input device 2012 may include a touchscreen and/or a mouse. The device 2812 can be used to identify elements to blow up for greater detail, to form connections between fiber-optic elements by drag-and-drop operations, to identify connections to be deleted or broken, to enter attribute information for defining fiber-optic network elements, and the like. The input/output device 2814 executes communications with the platform 2804 or other platforms to implement the functionality of the system 2800. Finally, the application 2816 comprises software and/or other logic for executing the system functionality. In cases where the system 2800 is fully executed on a user device 2802, the application 2816 executes all the functionality as discussed below. In other cases, the functionality of the system 2800 may be distributed between the user devices 2802 and the platform 2804.

Although the platform 2804 is illustrated as a single element in FIG. 28, it will be appreciated that the functionality of the platform 2804 may be distributed over multiple machines that may be in a single location or geographically distributed. Moreover, such functionality may be replicated on more than one machine or periodically moved between machines for redundancy and load-balancing. The illustrated platform 2004 generally includes a network information database 2012, a mapping database 2820, a processor 2822, and input output module 2024, and a drawing tool 2826. The network information database 2818 stores information regarding a fiber-optic network including a topology of the network, information regarding starting points and ending points of fiber-optic elements, information regarding attributes of the various fiber-optic elements, label information, and any other information of interest concerning a fiber-optic network. As discussed below, the network information database 2818 may be updated based on information entered on the user devices 2802 such as information defining and modifying network elements and connections.

The mapping database 2820 includes information for providing geographic maps for use in connection with the fiber-optic network. For example, the database 2820 may include Geographic Information Services (GIS) mapping information. Such mapping information may be useful to depict various elements of the fiber-optic network in relation to geographic references such as streets, intersections, geographical points of interest, and the like. The processor 2822 manages communications with the user devices 2802, accesses the databases 2818 and 2820, and performs various other functions of the system 2800.

The input/output module 2824 executes communications with the user devices 2802 via the network 2806. For example, the module 2824 may format communications in accordance with an Application Programming Interface (API) or other defined communications protocol. The drawing module 2826 is operative to automatically draw connections based on information input by the user. For example, the information may include attributes regarding a fiber-optic element input by the user or drag-and-drop operations for connecting particular optical fibers. The module 2826 can automatically draw and redraw connections based on such inputs without requiring further action from the user. As discussed below, a user can use the system 2800 to define, modify, and visualize connections in a fiber-optic network.

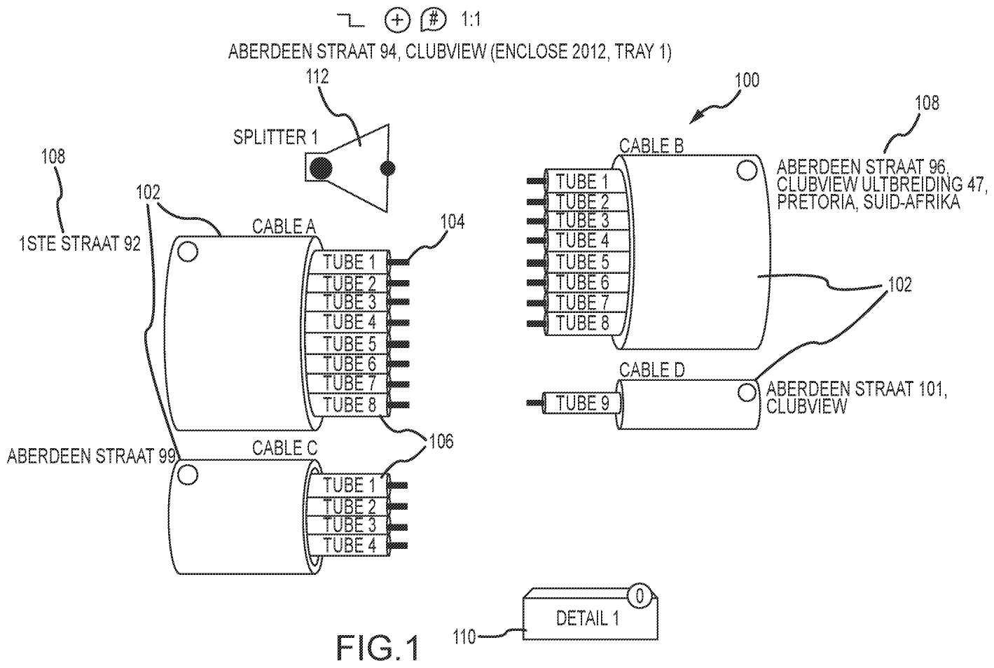

FIG. 1 is an illustration of a user interface 100 of a computer-based tool in accordance with a first embodiment of the invention. The interface 100 shows a number of optical elements that are brought together at connection or splice point of an optical network. The optical elements may be brought together at a physical splicing enclosure such as a splice box or cabinet. The optical elements include cables 102 that carry either fibers 104 or tubes 106 within the cables 102 that contain the fibers 104. Accordingly, whatever structure of fibers 106 that exists within cables 102 may be illustrated by the computer-based tool of the present invention. The various tubes 106 and fibers 104 may be labeled with letters, numbers and colors to distinguish and assist in identifying them to the user.

FIG. 1 also shows that each of the cables 102 may include a label 108 that identifies where each of the cables 102 is coming from. The labels 108 may include street numbers, physical splicing locations, junction boxes, or whatever label is needed in order to identify where the cable is coming from. The physical splicing locations that are illustrated in FIG. 1 may be referred to as a splicing tray or tray. Such trays are physical devices that hold the mechanical connections in optical networks.

FIG. 1 is a high-level view that initially shows cables 102, tubes 104 and optical fibers106 but not the physical splices between them. It should be understood that the computer-based tool may illustrate physical splice locations or trays for cables 102 with hundreds and even thousands of fibers 106. Such connections are shown in one or more detail boxes 110 that will be described in more detail below. The interface 100 can also show additional network components such as splitters 112.

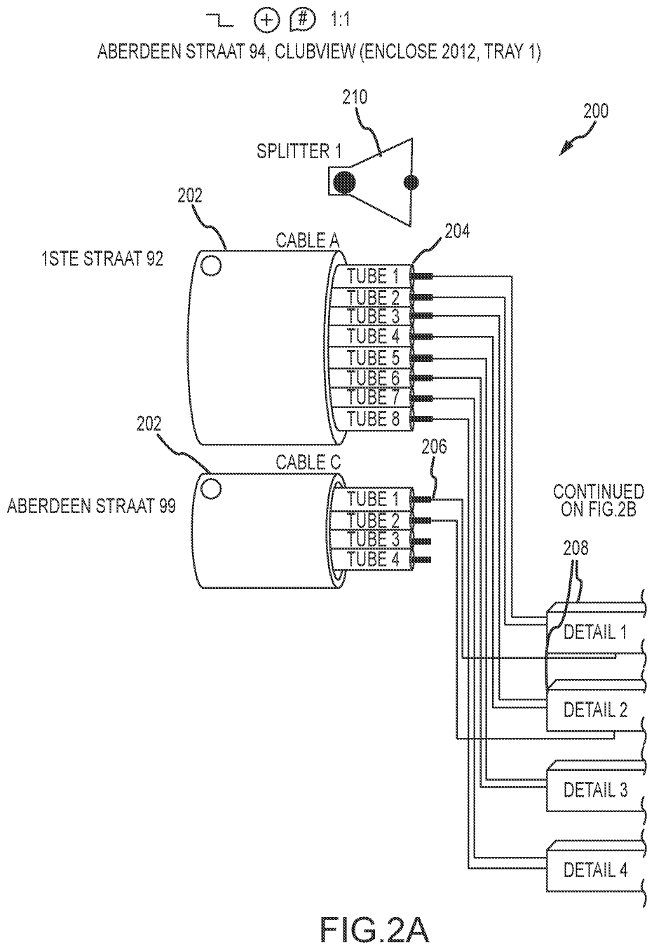

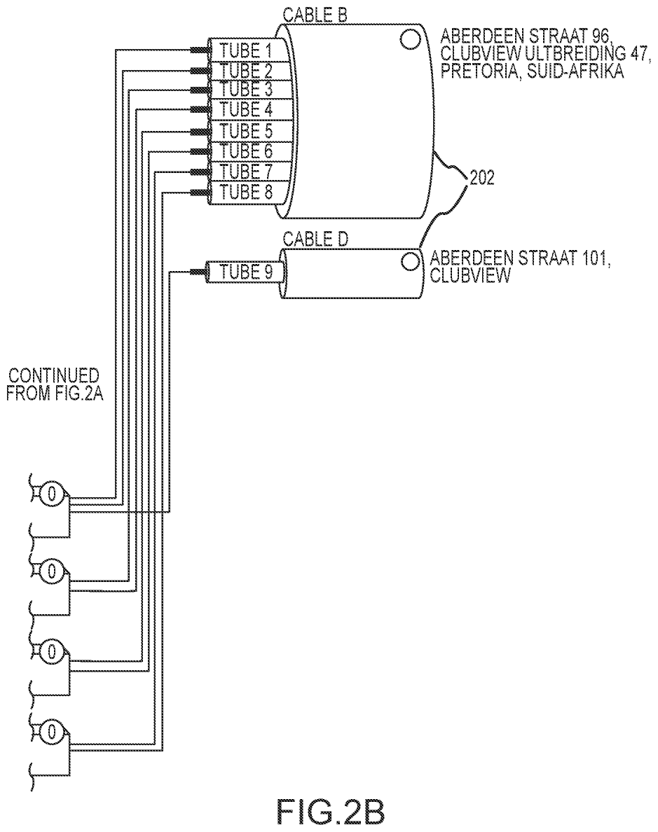

FIGS. 2A-2B are illustrations of a further user interface of the first embodiment of the invention that illustrates a greater level of detail. In FIGS. 2A-2B, connections or splices between specific cables 202, tubes 204 and fibers 206 are shown as well as any other components such as splitters 210. As will be understood from the description below, the graphical splices are created by using a cursor device, such as a mouse or touch screen, for dragging and dropping connection points. That is, a cursor may be positioned on a first connection point (e.g., fiber end) of a desired connection. The cursor device can then be activated (e.g., clicked) to select the first point and held while the cursor is dragged to a second connection point (e.g., another fiber end) where the cursor device can be released. The computer-based tool is then operative to automatically draw the connection between the points with appropriate image elements, such as color coding, and an associated data collection (e.g., database for the optical network) may be automatically updated to reflect the new connection.

For example, a user may click on a first fiber 206 in a specific cable 202, and then drag a cursor to a second fiber 206 in another cable 202 or a second fiber 206 in the same cable 202. However, instead of showing a line directly between the first and second fibers 206, the computer-based tool may create a detail box 208 as shown. As more and more connections are made between different fibers 206 using the drag and drop method, additional detail boxes 208 may be added to the schematic diagram being displayed. The number of connections hidden within each detail box may be changed as desired, and the total number of detail boxes may be unlimited.

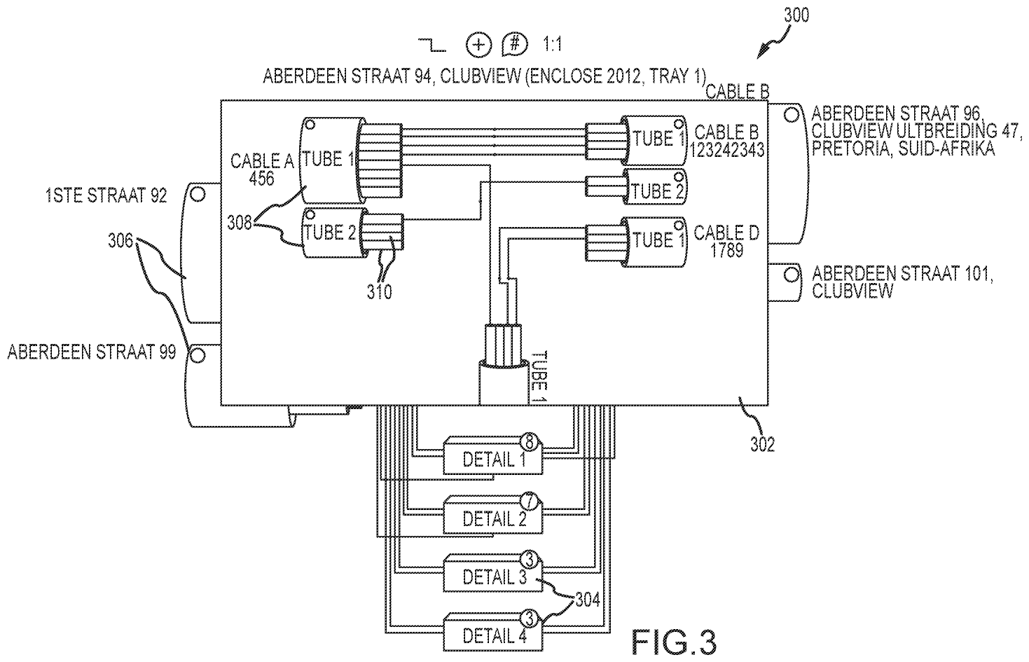

FIG. 3 is an illustration of another interface 300 of the first embodiment of the invention. This interface 300 illustrates a Quickview feature of the software program. The Quickview feature brings up a detailed and exploded view 302 of all the connections that are made within a specific detail box 304. The detailed and exploded view may appear over the high-level view of the cables 306 such as shown in FIGS. 1 and 2. For example, the view 302 may be obtained by clicking on a desired detail box 304 in the interface 300.

The detailed and exploded view 302 illustrates in detail the actual connections being made between fibers 310 in the selected detail box 304 and illustrates each of the cables 306 as well as the tubes 308 where the fibers 310 are located. For example, FIG. 3 shows that there are multiple fibers 310 within each tube 308 within each cable 306 and shows exactly which fibers 310 are connected.

It is also noted that each detail box 304 now shows a number in a circle in an upper right corner of the detail box. This number may refer to the specific number of connections that are being illustrated within that specific detail box.

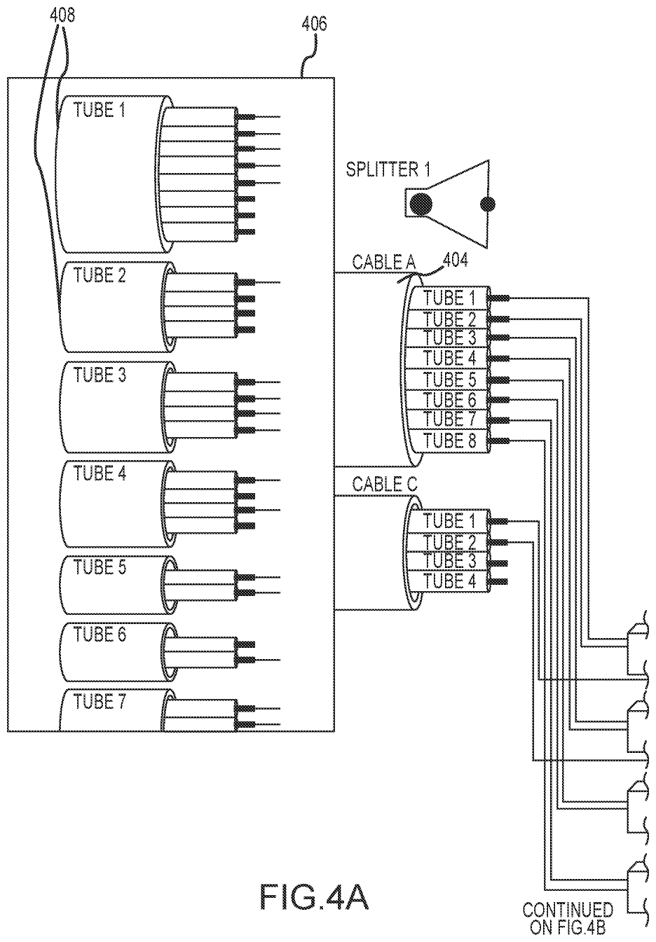

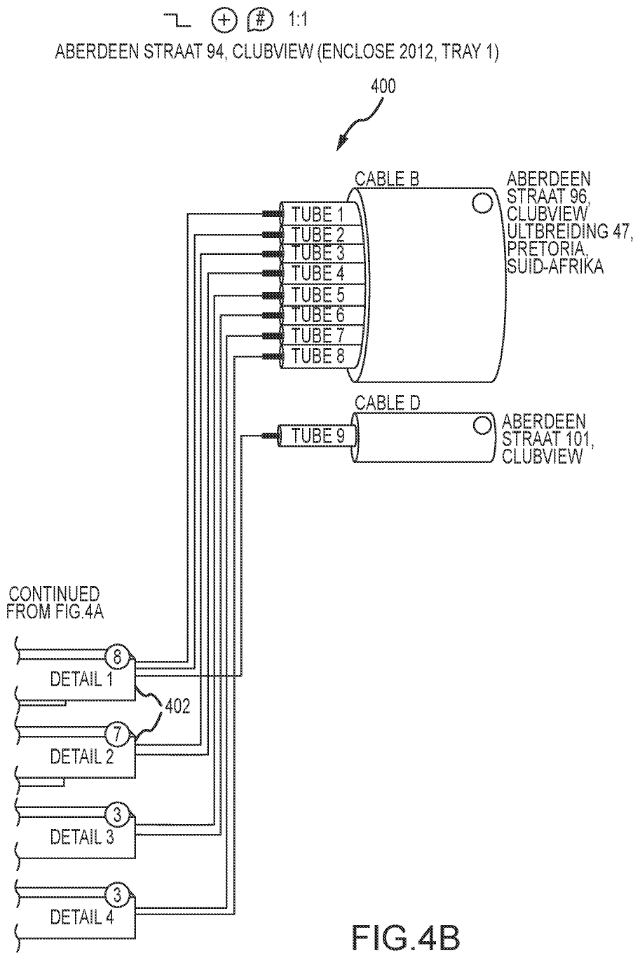

FIGS. 4A-4B are illustrations of a further interface 400 of the first embodiment of the invention. As shown, the Quickview feature can not only used to explode the detail within a detail box 402 but can also provide an expanded view 406 of the connections of just a specific cable 404. Specifically, the view 406 of cable A shows all of the tubes 408 in cable A and also illustrates which detail boxes 402 can be selected to illustrate a detailed view of connections. All other connections from all other cables may be hidden or greyed out so that the fibers of cable A are highlighted and therefore more easily traced to a respective detail box 402.

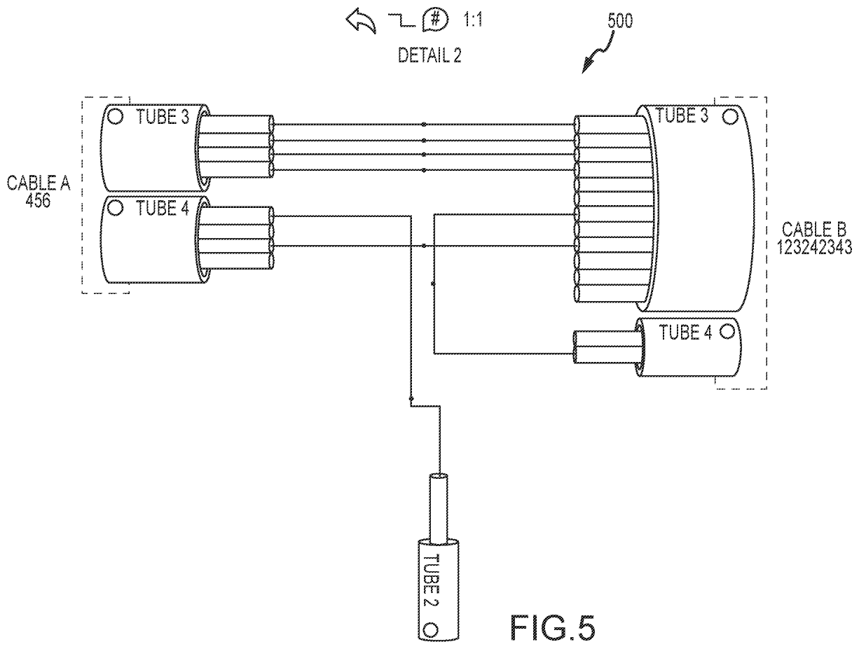

FIG. 5 is an illustration of a still further interface 500 of the first embodiment of the invention. This interface 500 shows that the user may obtain more than just a Quickview of each detail box and cable but may also open and expand a Quickview so that it fills the entire field of vision on the display. Advantageously, connections may be added, deleted or changed within these exploded views using drag and drop process.

It is also noted that in each expanded Quickview, there are three sides where cables may be shown coming into a splicing tray: right, left and bottom.

Once the user has completed making changes within the expanded Quickview and the Quickview is closed, the changes to splices are immediately and automatically reflected in high-level views such as the views shown in FIGS. 1 and 2. The changes may also be reflected in a database of the network topology.

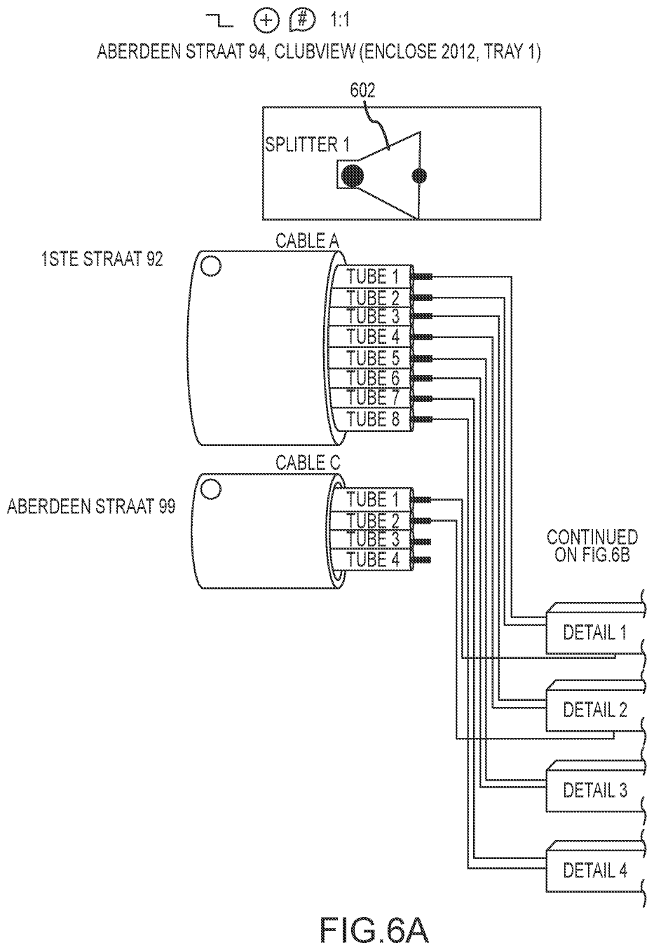

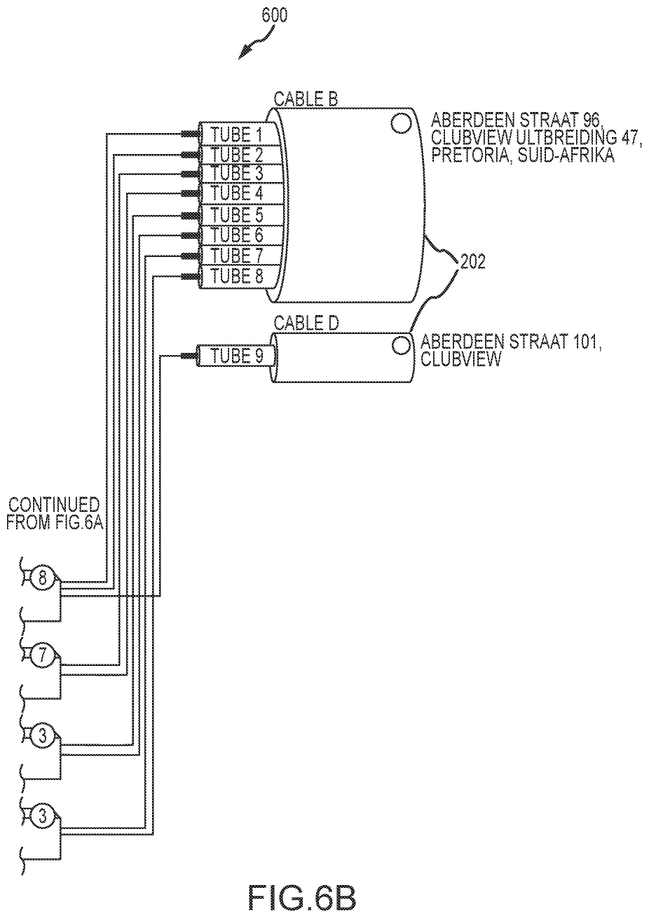

FIGS. 6A-6B are illustrations of another interface 600 of the first embodiment of the invention. This interface 600 highlights a splitter 602. Splitters 602 may also be added to the interface 600 when a connection is made between more than two fibers at the same time. That is, an optical signal from a given fiber may be split for transmission to two different cables and optical signals from the two cables may be transmitted to the given fiber.

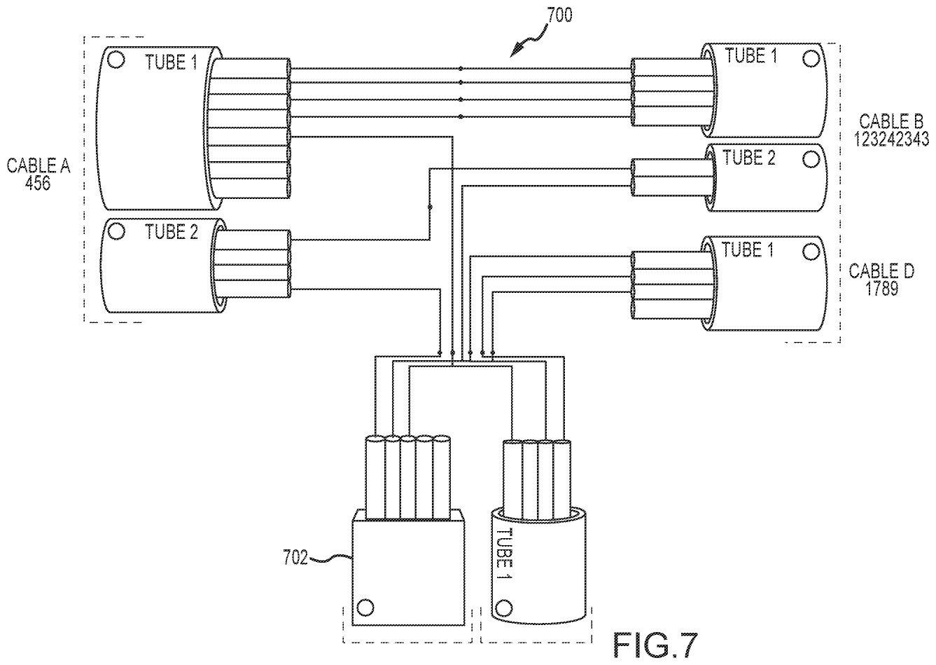

FIG. 7 is an illustration of another interface 700 of the first embodiment of the invention and shows an expanded Quickview for a splitter 702. When splitters 702 are used in the overview or in a detail box, the splitters 702 are also shown in the Quickview. As shown, at least some of the connections implemented in connection with the splitter 702 can be more than 1:1 connections, e.g., 2:1 connections.

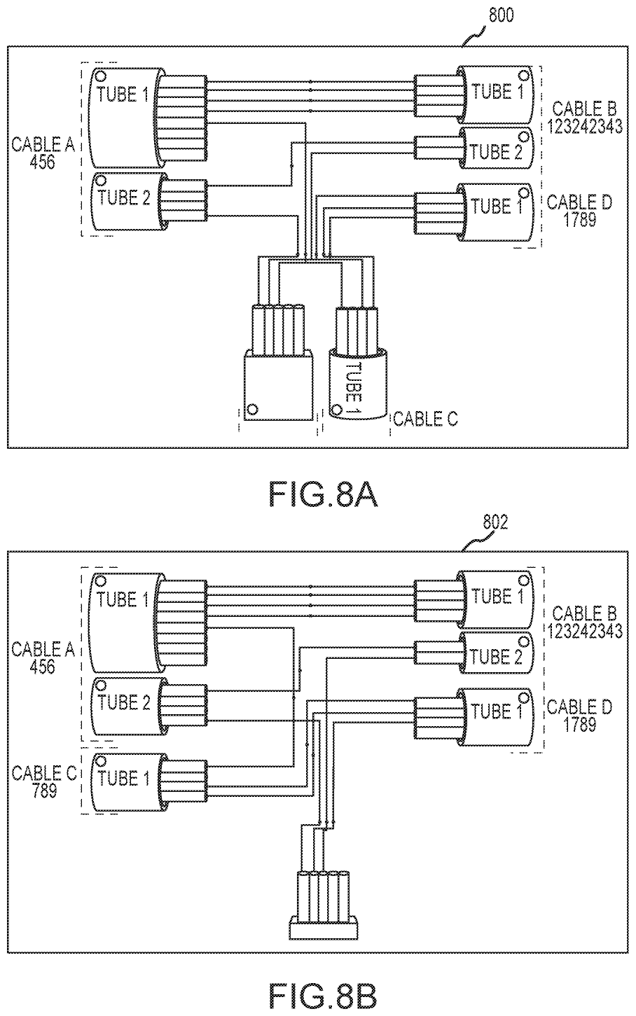

FIGS. 8A and 8B show interfaces 800 and 802 of the first embodiment and illustrate an important feature of the invention. Specifically, these interfaces 800 and 802 show that Cable C, Tube 1 has dynamically changed positions. This movement of the cable may be performed by dragging the cable by a drag and drop movement using the cursor. FIG. 8A shows the position of Cable C, Tube 1 before movement, and FIG. 8B shows the new position of Cable C, Tube 1 after dragging. Note that all of the fibers having specific connections to Cable C, Tube 1 have all been automatically redrawn. This provides a substantial time savings in relation to having to manually re-draw the connection point.

In the first embodiment, the redrawing of the splices between fibers may occur dynamically as the cable is being dragged or, alternatively, the redrawing may occur after the cable is dropped in its new position after dragging.

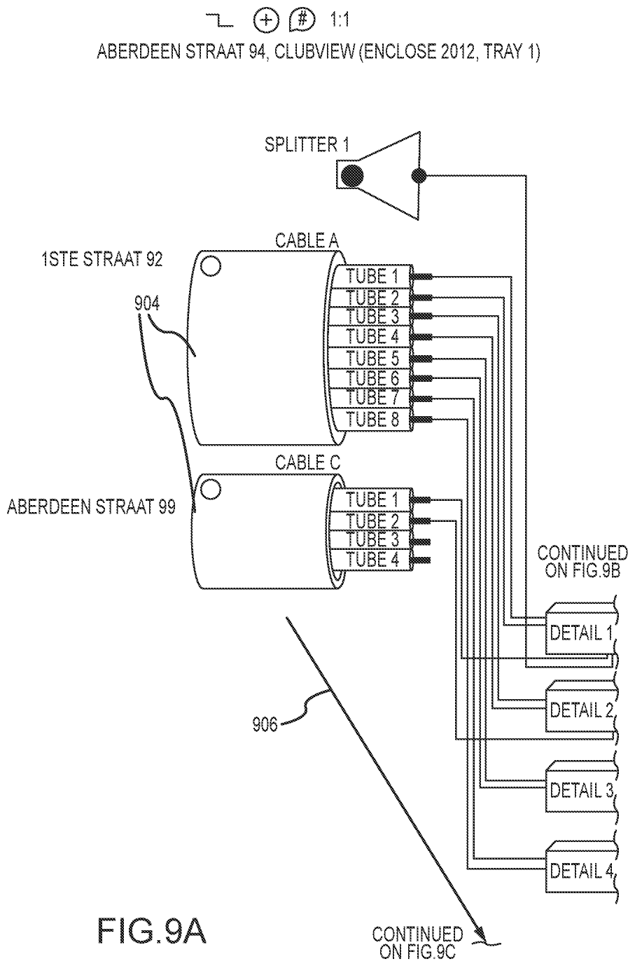

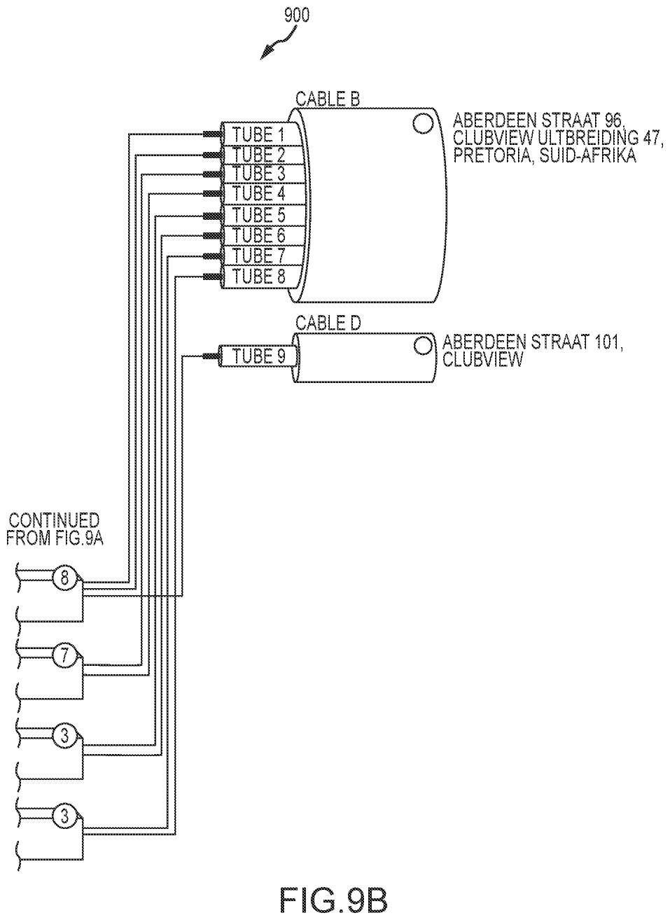

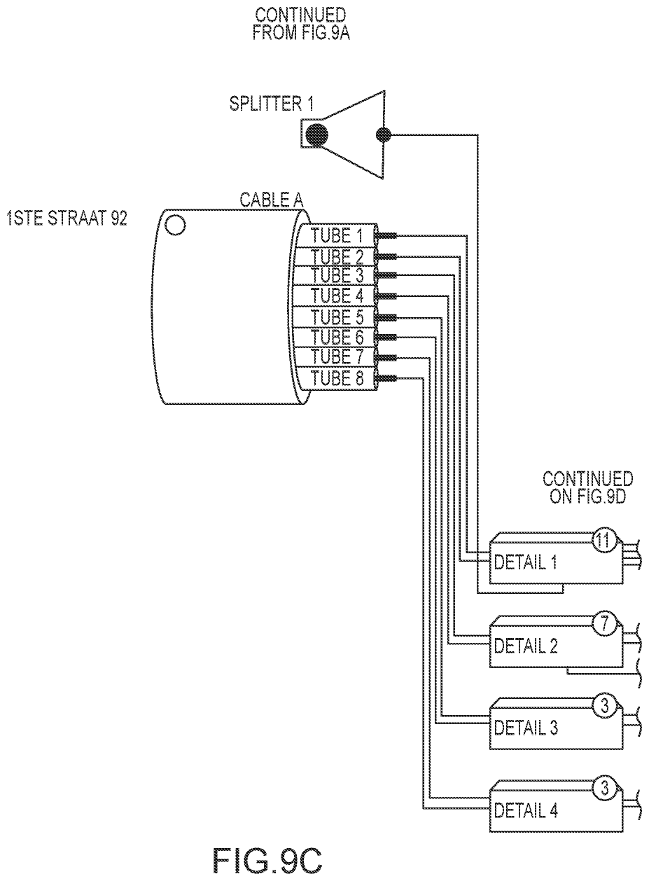

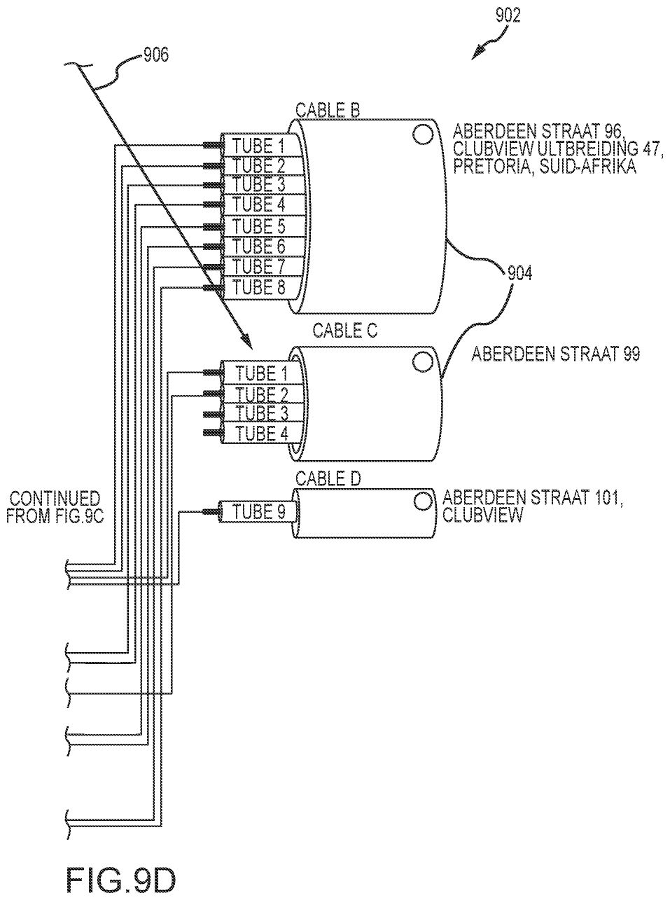

FIGS. 9A and 9B are an illustration interfaces 900 and 902 of the first embodiment of the invention. These interfaces show that even in a high-level view, cables 904 may be dragged from one location to another using the drag and drop feature, as generally indicated by arrow 906 extending between FIGS. 9A-9B. In FIGS. 9A-9B, Cable C is moved from the left side of the connection point to the right side in FIGS. 9C-9D. All connections are redrawn automatically.

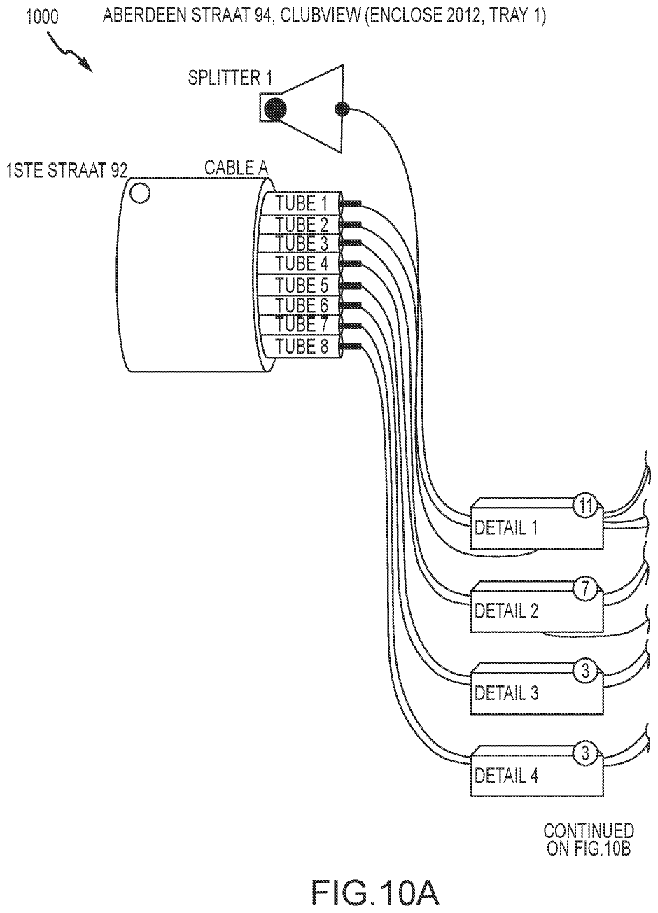

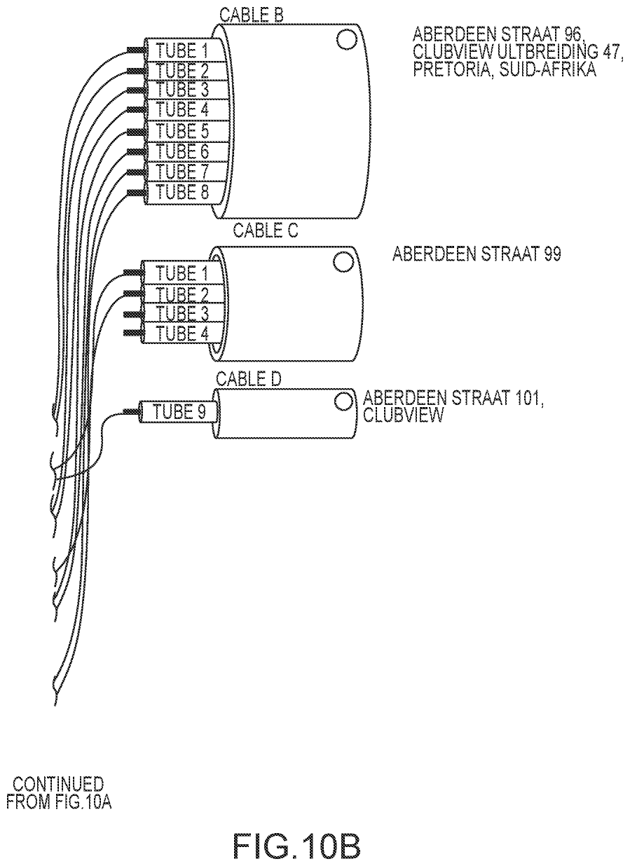

FIGS. 10A-10B are illustrations of a further interface 1000 of the first embodiment of the invention. This interface 1000 shows that the computer-based tool may also include a smoothing feature for the lines that are showing connections. Thus, instead of making sharp right angles to change directions, the connections are shown with rounded corners and no sharp angles to better reflect the appearance of optical fibers at a connection point. These smoothed connection lines may appear in the Overview and the Quickview detailed views.

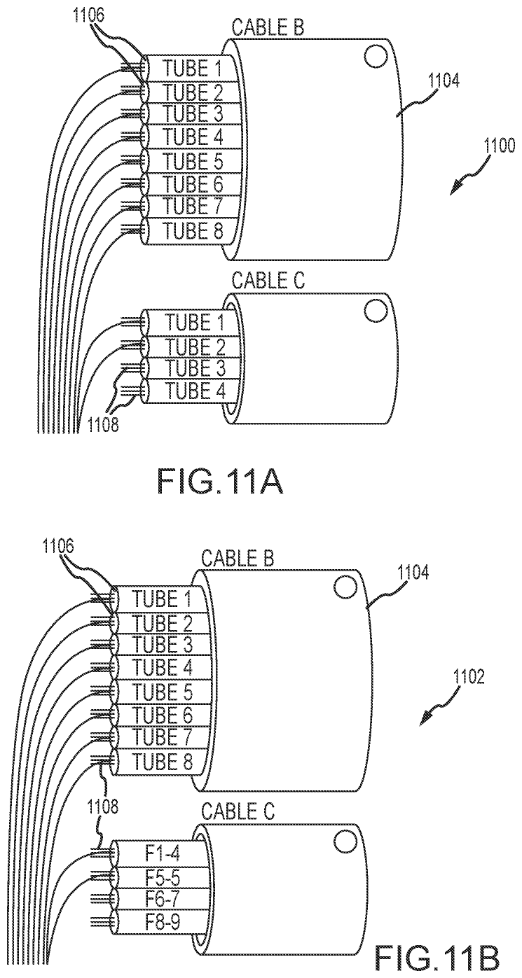

FIGS. 11A and 11B are an illustration of further interfaces 1100 and 1102 of the first embodiment of the invention. These interfaces 1100 and 1102 show that labels 1104 on the cables 1104, tubes 1106, and fibers 1108 may also be changed as needed. FIG. 11A shows the original labels given to the tubes 1106 and FIG. 11B shows the changed labels.

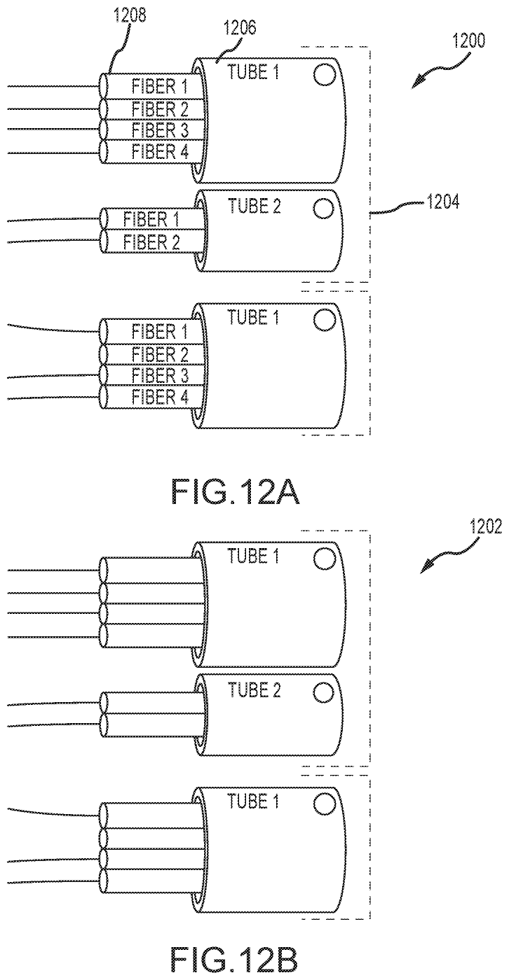

FIGS. 12A and 12B are an illustration of further interfaces 1200 and 1202 of the first embodiment of the invention. These interfaces show that labels on the cables 1204, tubes 1206, and fibers 1208 may be toggled on and off. For example, FIG. 12A shows the original labels given to the tubes 1206 and fibers 1208, and FIG. 12B shows the labels on the fibers 1208 toggled off.

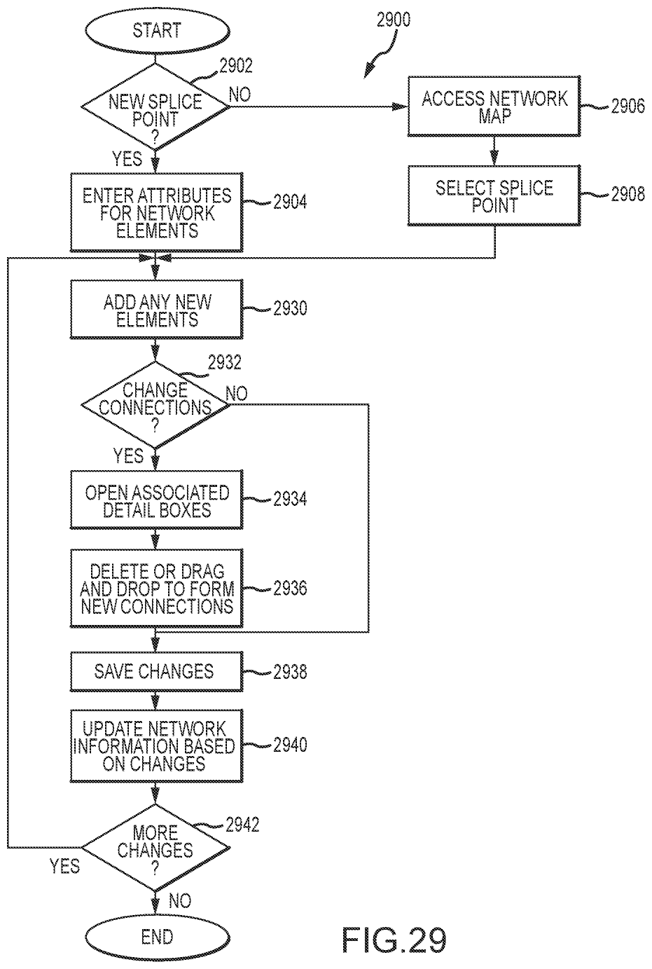

FIG. 29 is a flowchart illustrating a process 2900 that summarizes the operation of the first embodiment of the invention. The process 2900 relates to defining, modifying, and visualizing connections at a given connection point or splice point. The illustrated process 2900 begins by determining (2902) whether the operations will be performed in relation to a new splice point or an existing splice point. If it is desired to perform operations in relation to an existing splice point, the user can access (2906) a network map and select (2908) a splice point. For example, the user may move a cursor to a graphical element associated with the splice point and select the splice point by clicking on the graphical element.

If the user desires to define a new splice point, the user may begin by entering (2904) attributes for one or more network elements. For example, the user may elect to make connections between multiple cables at the connection point. Thus, the user may identify the desired number of cables. Then, for each cable, the user may identify a number of fiber-optic tubes to be included in the cable. For each of the tubes, the user can indicate a number of optical fibers. In some cases, a cable may include a combination of tubes and loose fibers. The user may then add (2930) any additional or new elements. For example, a user may add cables, tubes, and/or fibers to an existing splice point and may add other optical elements such as a splitter.

The illustrated process 2900 further involves determining (2932) whether to change any connections at the splice point. If it is desired to change connections, the user may open (2934) a detail box to view the existing connections. The user can then delete (2936) connections or form new connections. For example, the user may execute a drag-and-drop operation to form a new connection between two fibers. In addition, a user may identify an existing connection to be deleted or broken. For example, the user may right click on the connection and select, from a menu, to delete the connection.

If no changes to connections are desired, steps 2934 and 2936 may be omitted. In any event, once the user is satisfied with the status of the splice point, the system may save (2938) the connections. In this regard, connections may be continuously and automatically updated or may be saved when requested by the user. In either case, the network information may be updated (2940) to reflect the changes made by the user. Accordingly, when a user next accesses the splice point, the changes will be shown. If more changes are desired (2942) the process may be repeated. Alternatively, the user may conclude the process and close the application.

In a second embodiment of the invention, the computer-based tool may be modified to illustrate patch panels. Patch panels may often be disposed near computer servers and telephone switches and allow connections to be made and easily changed between various devices coupled to the patch panels as is known to those skilled in the art. In this regard, an optical element such as an optical fiber may have terminals that can be plugged into ports or receptacles on a patch panel. However, the maze of patch cables may easily obscure connections and make them difficult to trace.

Patch panels come in a variety of configurations relating to the number and arrangement of ports on a faceplate of the panel. In order to facilitate rapidly creating a graphical face plate, the user may first input certain parameters. These parameters may include the number of columns, the number of rows, and the number of ports per column. Thus, a user interface may be provided that allows a user to specify values for each of these parameters, e.g., via a fill-in box or pull-down screen. These values can then be used to automatically generate a graphical representation of the patch panel.

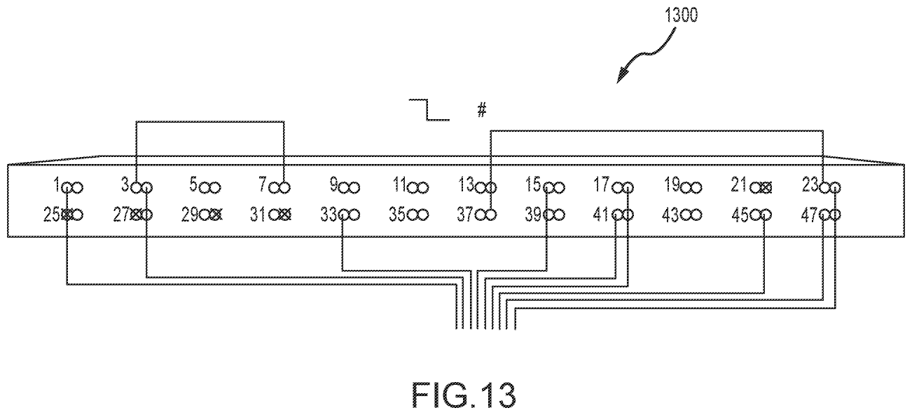

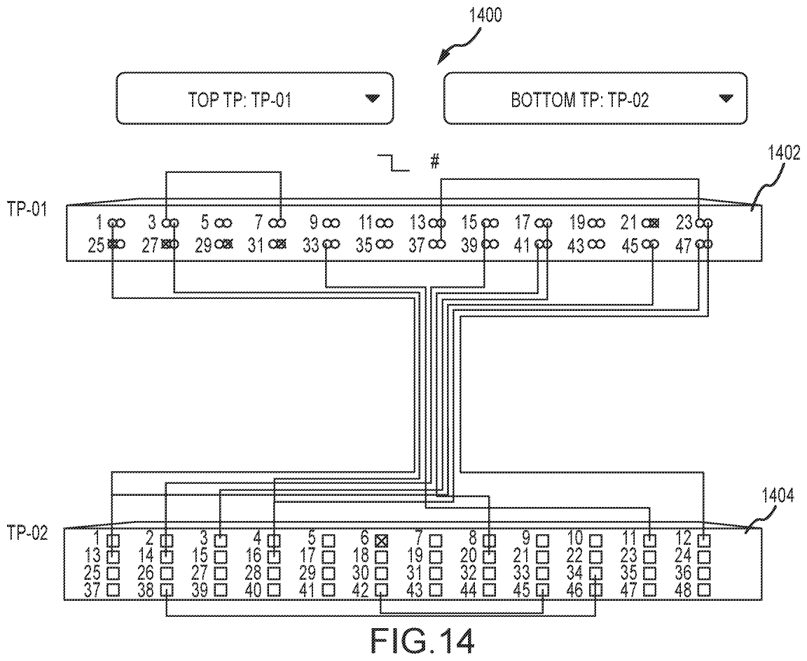

FIG. 13 is an illustration of a patch panel 1300 that may be created in accordance with the second embodiment. The illustrated patch panel 1300 has 12 columns, 2 rows, and 2 ports per column.

FIG. 14 is an illustration of another interfaced 1400 of the second embodiment. This interface 1400 shows 2 patch panels 1402 and 1404, TP-01 and TP-02. The connecting lines show which ports are connected between the patch panels. It should be noted that some of the connectivity lines representing patch cables are illustrated as extending through the top of patch panel 1402 or through the bottom of the patch panel 1404, and they go between ports of the same patch panel as is sometimes the case in optical networks.

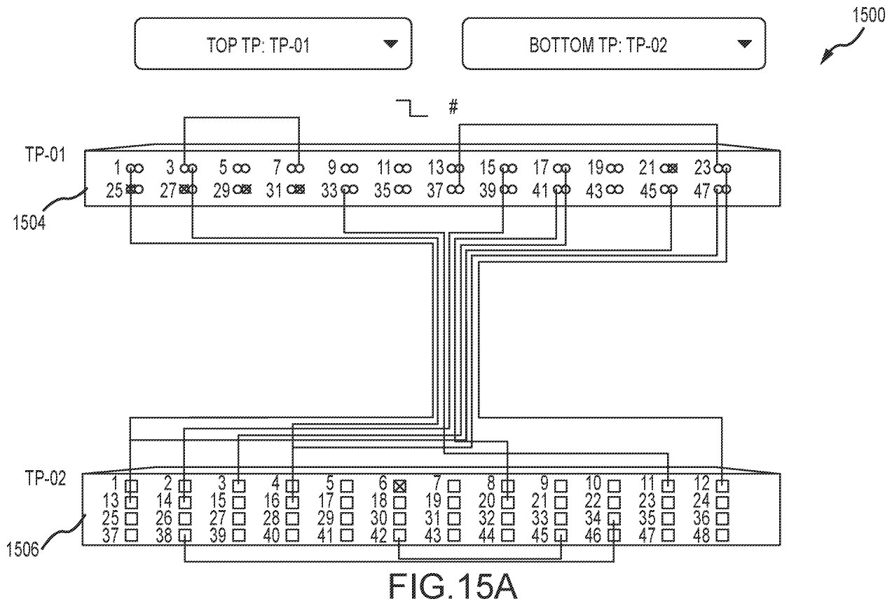

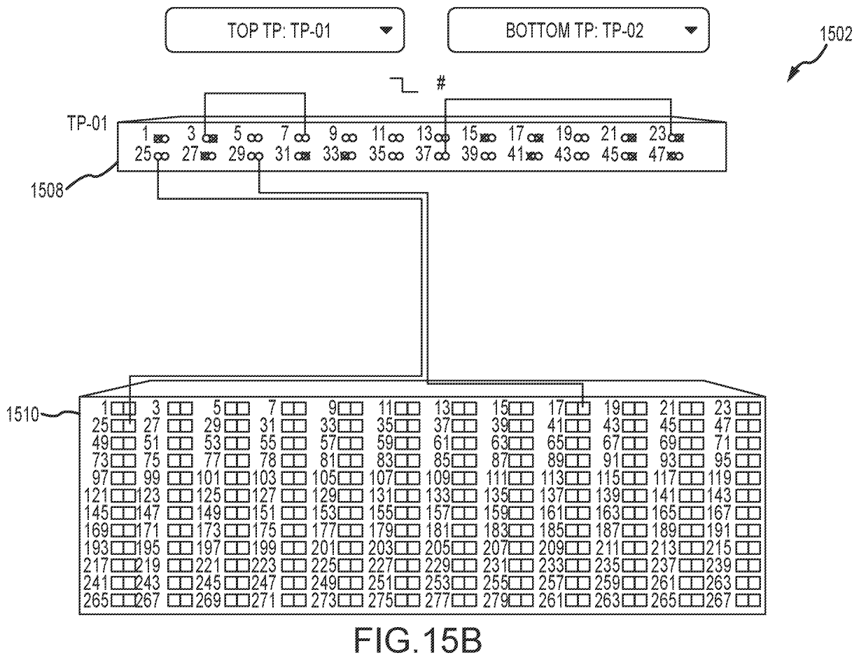

FIGS. 15A and 15B are illustrations of interfaces 1500 and 1502 of the second embodiment of the invention. FIG. 15A shows two patch panels 1504 and 1506 and the interconnecting lines between ports. FIG. 15B illustrates the ability to show differently configured patch panels 1508 and 1510. It will be appreciated that, while two patch panels are shown, more than two patch panels may be illustrated in the interface 1500 or 1502 and panels may be switched out of the interface. For example, the user may select to move one of the patch panels shown out of sight by swiping on the panel that the user wants to replace, or by selecting a “change” button that enables the user to replace one of the patch panels shown for a different one. For example, if there were four patch panels being used, swiping on one of the panels may cause one of the patch panels not shown to appear. This action may be continued until all of the patch panels have been displayed. This action may also continue in a loop, cycling through all of the patch panels one at a time.

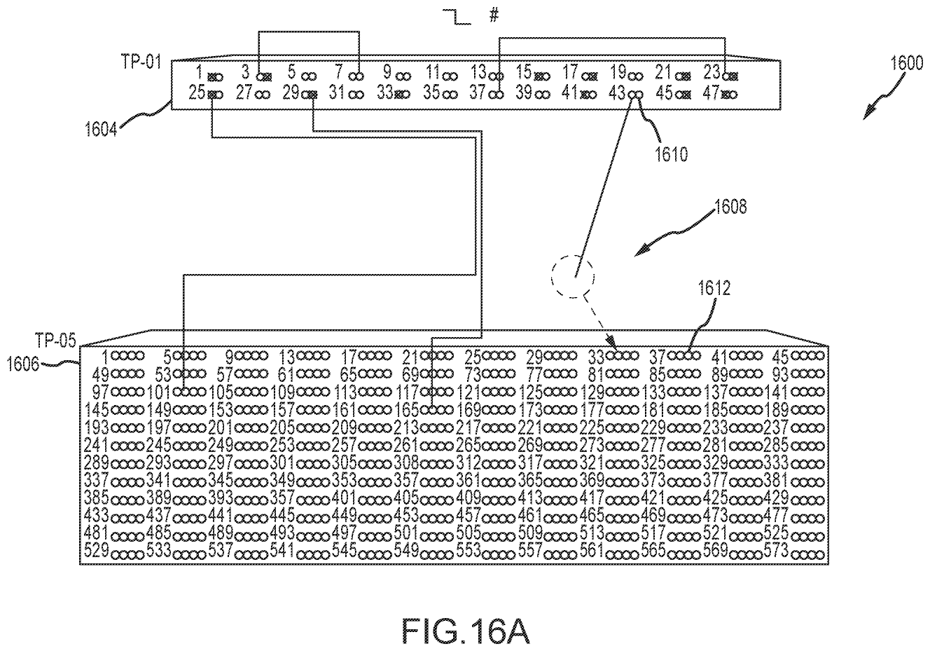

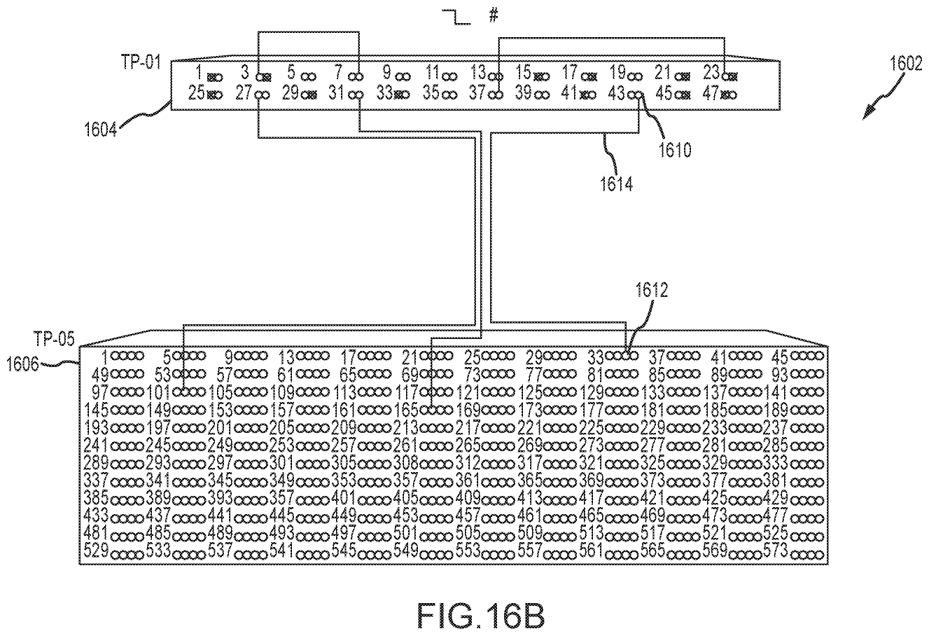

FIGS. 16A and 16B show interfaces 1600 and 1602 that illustrate operation of a connection process of the second embodiment of the invention. FIG. 16A shows two patch panels 1604 and 1606 and indicates a connection 1608 that is being made between a port 1610 of the first patch panel 1604 to a port 1612 of the second patch panel 1606. FIG. 16A illustrates the interface during the process for connecting the port 1610 on the first patch panel 1604 to the port 1612 on the second patch panel 1606.

The user moves a cursor over the port 1610 on the first patch panel 1604 and may perform an action such as click and drag. Thus, the user may click on and hold down a mouse button, and then drag the cursor to the desired port 1612 on the second patch panel 1612. When the desired port 1612 on the second patch panel 1606 is reached, the user may release the mouse button and the computer-based tool may draw a line from the first panel 1610 to the second patch panel 1612 at the selected ports 1610 and 1612.

FIG. 16B shows a resulting line 1614 connecting the ports 1610 and 1612 between the first patch panel 1604 and the second patch panel 1606.

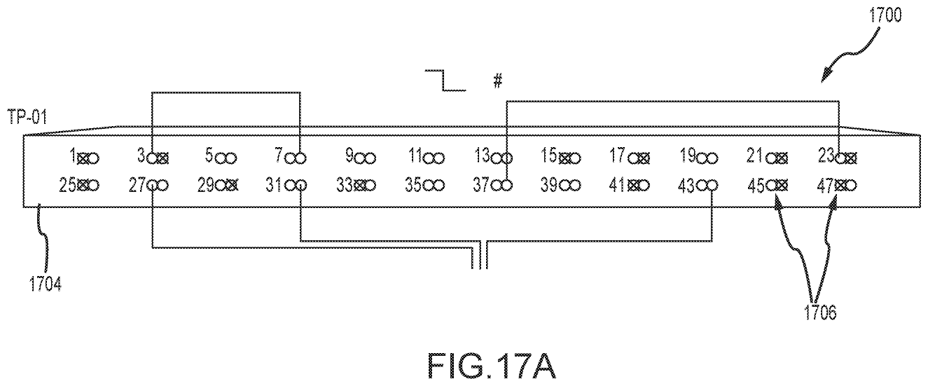

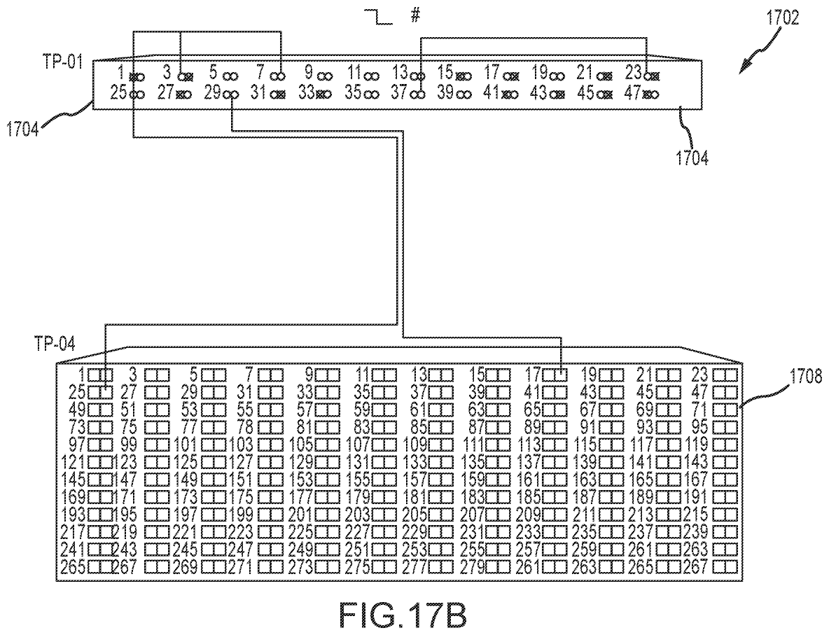

FIGS. 17A and 17B show illustrations of interfaces 1700 and 1702 of the second embodiment of the invention. FIG. 17A shows a first patch panel 1704. Several of the ports 1706 include some marking indicating that the port 1706 is being used and is unavailable. If the user wants to see the patch panel that the unavailable port 1706 is connected to, the user may click on the marking.

FIG. 17B shows that when the user clicks on the marking on the port, the connected patch panel 1708 moves into view.

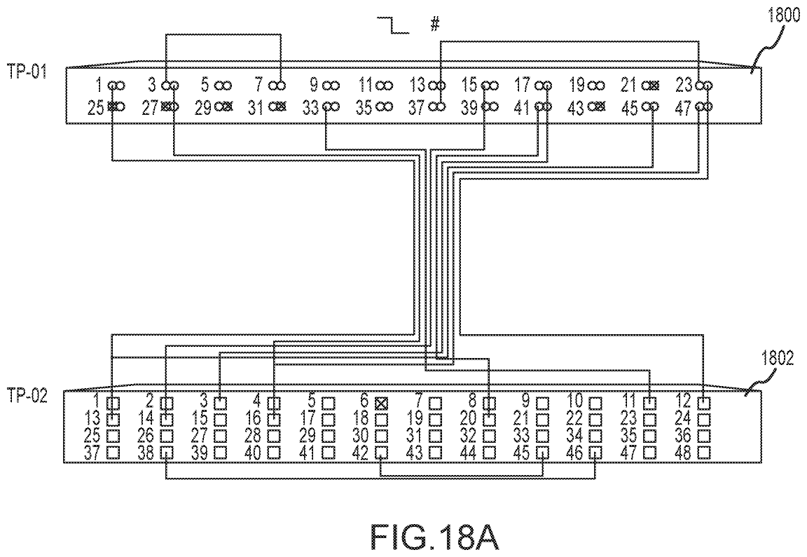

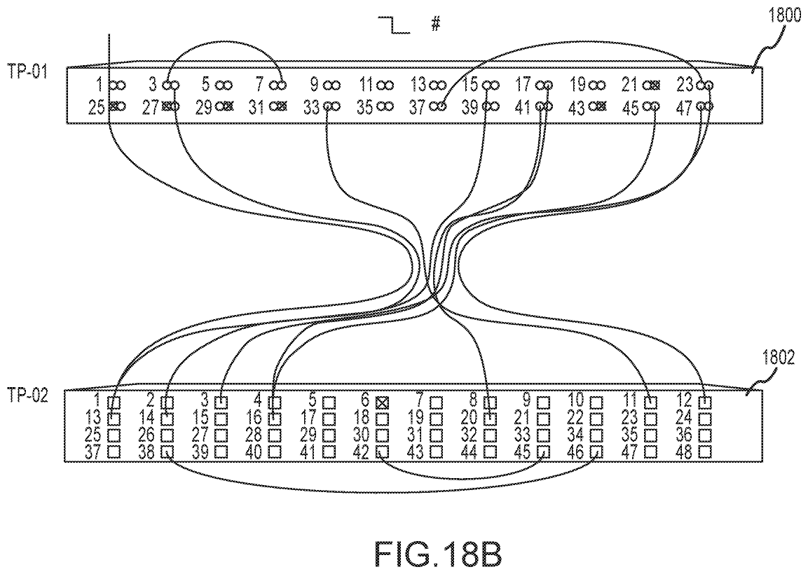

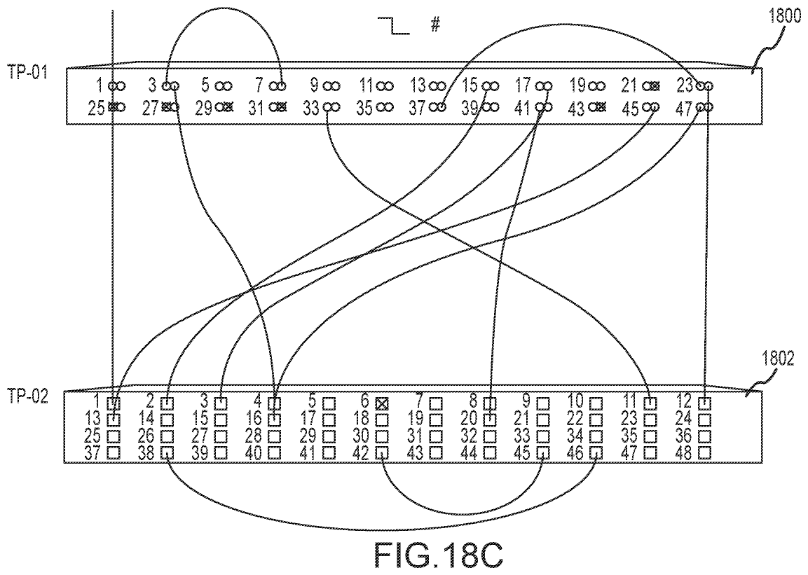

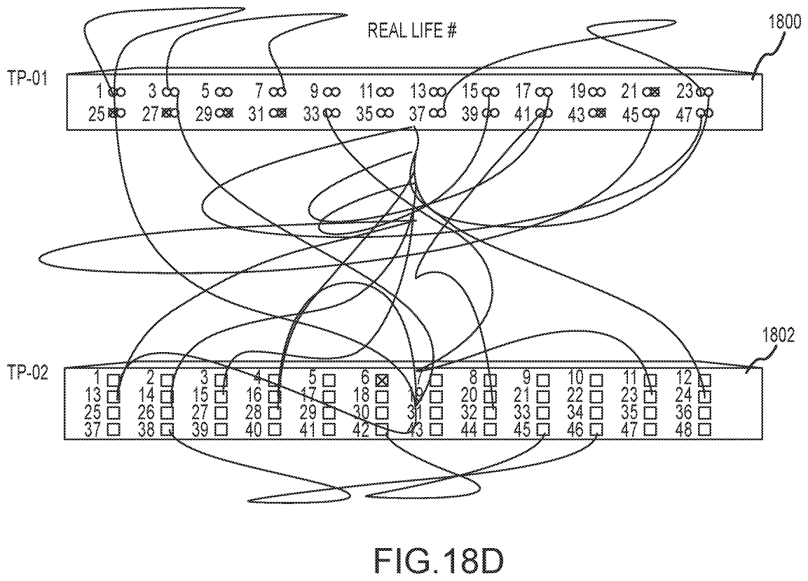

FIGS. 18A, 18B, 18C and 18D show various views of the connections between patch panels 1800 and 1802. These figures show that the connections may be shown as straight lines and right angles as in FIG. 18A, as smoother lines that all converge to a center region between the two patch panels as shown in FIG. 18B, and as the shortest and smoothest route between the patch panels 1800 and 1802 as shown in FIG. 18C. A final view shown in FIG. 18D is a view of the typical twisted and untraceable path that is typical of the actual connection paths between the two patch panels. A user can select a desired one of these views, or toggle between them, using an appropriate view selection interface, e.g., from a pull-down menu.

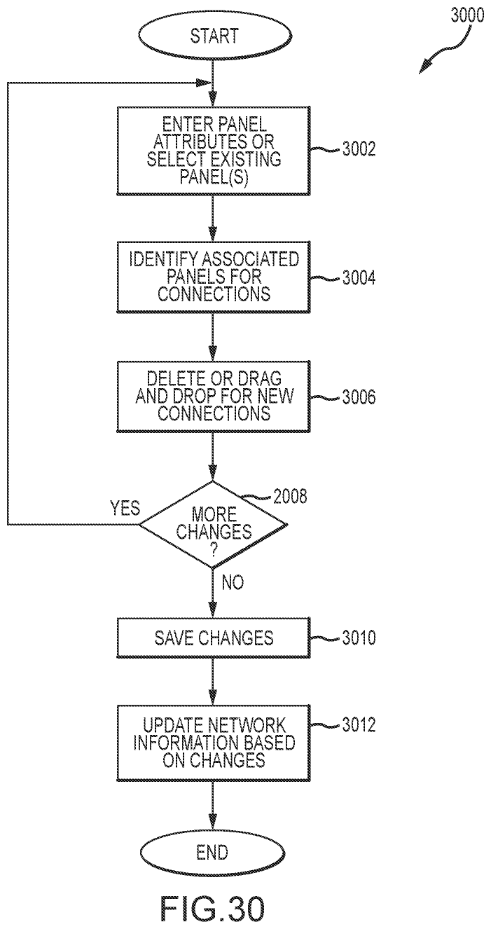

FIG. 30 shows a process 3000 that summarizes operation of the second embodiment of the invention. The process 3000 is initiated by entering (3002) panel attributes or selecting existing panels. That is, if the process 3000 will involve a new patch panel, the user can enter attributes of the patch panel such as the number of rows, the number of columns, and the number of ports per location in each column. If the process 3000 will involve an existing panel, the user may pull up a map of the fiber-optic network and click on the panel of interest.

The user may then identify (3004) associated panels for connections. As discussed above, certain ports on a panel may be marked to indicate that the port is unavailable. If the user clicks on the marked port, a connected patch panel may be displayed. In this manner, or by similar user inputs, the user can identify the patch panels of interest for a particular process. The user can then delete (3006) existing connections or make new connections. For example, existing connections can be deleted by right clicking on an existing connection and selecting “delete” on a drop-down menu. In addition, a user can execute a drag-and-drop operation to form a new connection between two ports of a single panel or two ports of different panels.

A determination (3008) may then be made as to whether additional changes are desired. If more changes are desired, the process is repeated. Otherwise, the changes may be saved (3010). In this regard, changes may be continuously and automatically saved as they are made or the changes may be saved when requested by the user. In either case, the network information may be updated (3012) to reflect the changes.

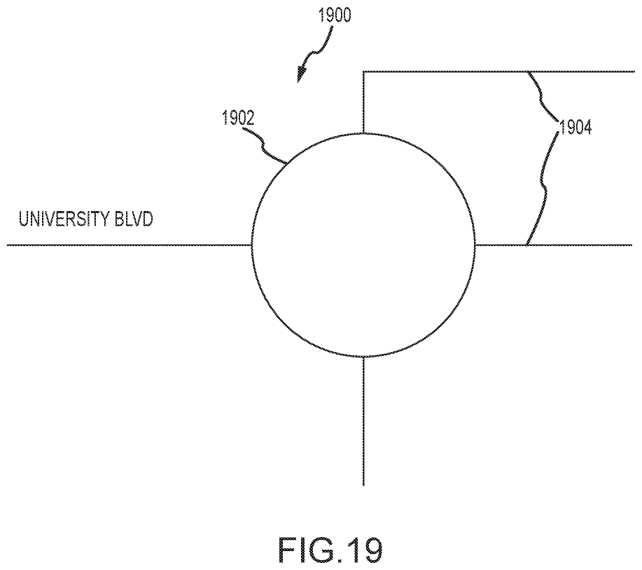

A third embodiment of the invention is described in relation to FIGS. 19-27. FIG. 19 is a bird's-eye view diagram 1900 of a street map with a manhole cover 1902 and duct banks 1904 superimposed thereon.

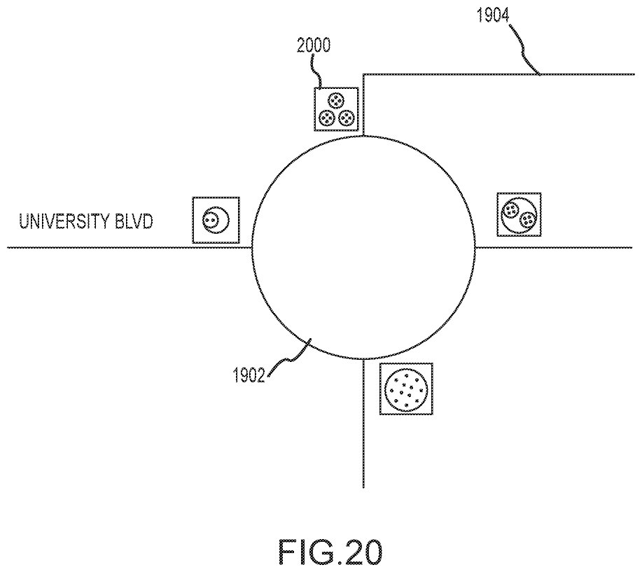

FIG. 20 is a modified view of FIG. 19 which now shows graphics 2000 that indicate the super ducts and inner ducts within each of the duct banks.

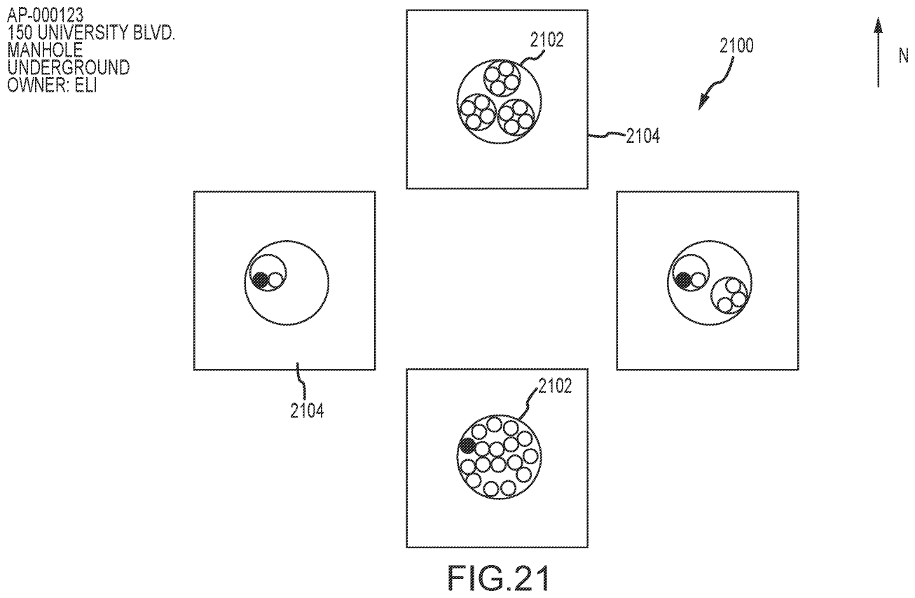

FIG. 21 show a butterfly drawing 2100 of the third embodiment of the invention. The butterfly drawing 2100 lays out the fiber elements 2102 of the duct banks 2104 of each wall of the manhole. In this case, there are four walls so there are four walls shown relative to each other. Each of the walls shows the cross-section of the duct 2104 that enters the manhole, and the direction from which the ducts enter.

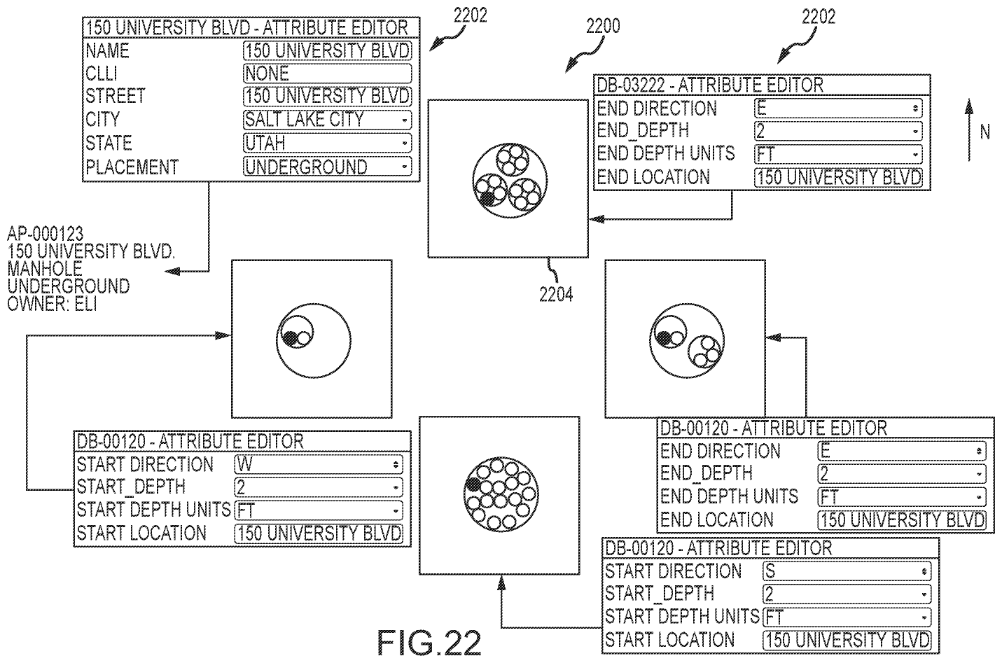

FIG. 22 shows butterfly drawing 2200 that may be rendered automatically using a database of information. The drawing 2200 shows detail views 2202 that may be displayed, for example, for each of the ducts that enters a manhole upon selecting the corresponding representation of the duct 2204 in the drawing 2200. The detail views 2202 include a number of fields of information concerning the duct 2204 such as the end location and depth of the duct. These attributes can be edited in the detail views 2202 and the edits can be reflected in the network database and subsequent drawings.

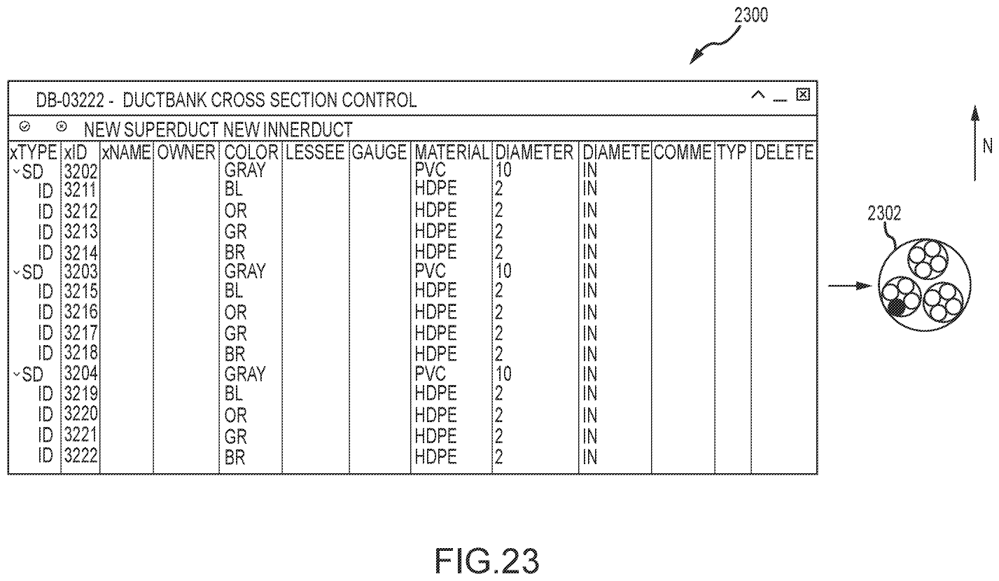

FIG. 23 shows a table 2300 and a duct cross-section 2302 that is generated by the table. For example, the table may define a duct, a configuration of innerducts, dimensions, and other information (e.g. materials and colors) of such elements. All of this data regarding the duct cross-section may be displayed in drawings generated by the computer-based tool.

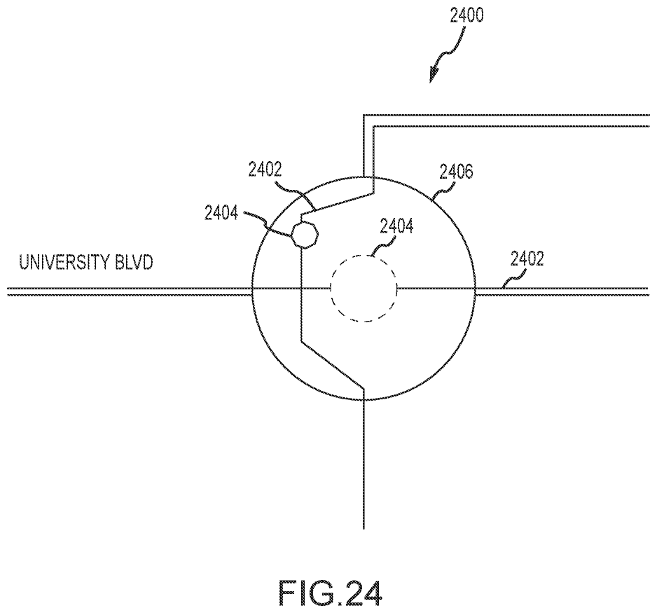

FIG. 24 is another bird's eye view 2400 of the street map of FIG. 20, but with added details. In particular, the cables 2402 and splice points 2404 in the manhole 2406 may be shown. Cabling, splices, and slack have been added to this drawing.

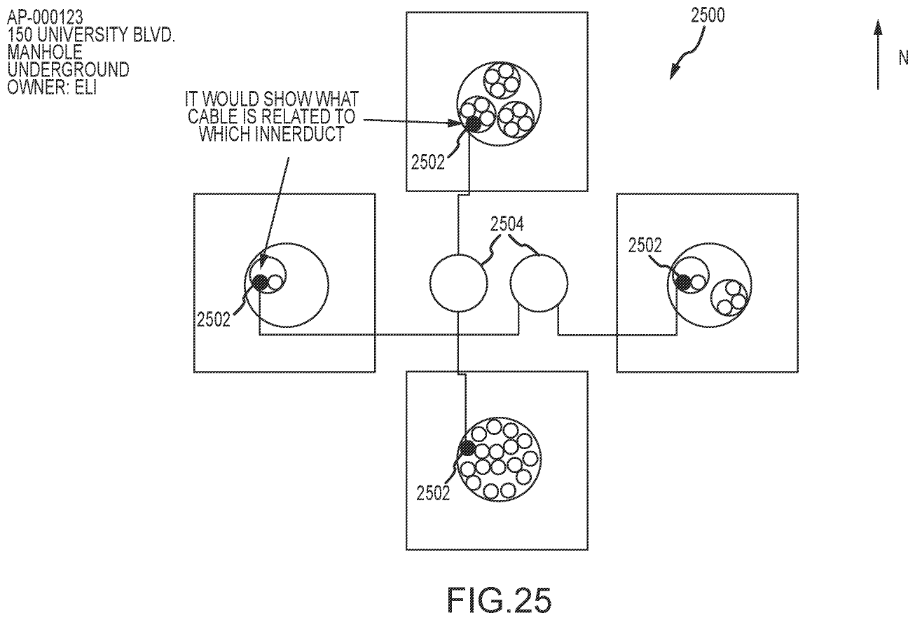

FIG. 25 shows what such cabling, splices, and slack may look like in a butterfly diagram 2500. Note that the specific fibers 2502 that are spliced together at splice points 2504 are shown.

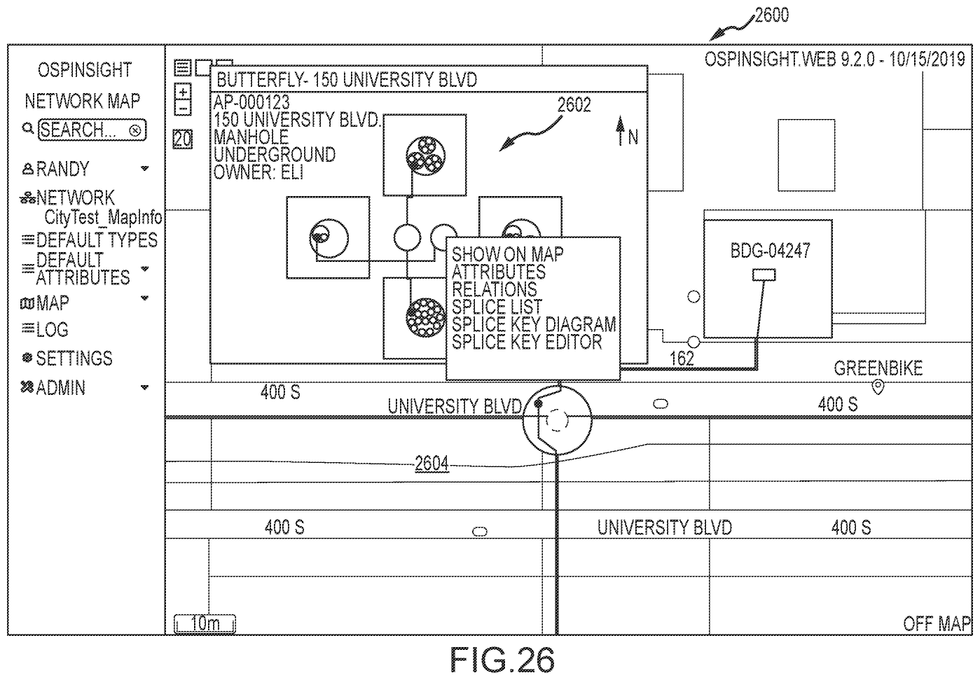

FIG. 26 is a screenshot 2600 that illustrates what may be displayed by the computer-based tool. Specifically, it is noted that the butterfly diagrams 2602 may be displayed over a street map 2604.

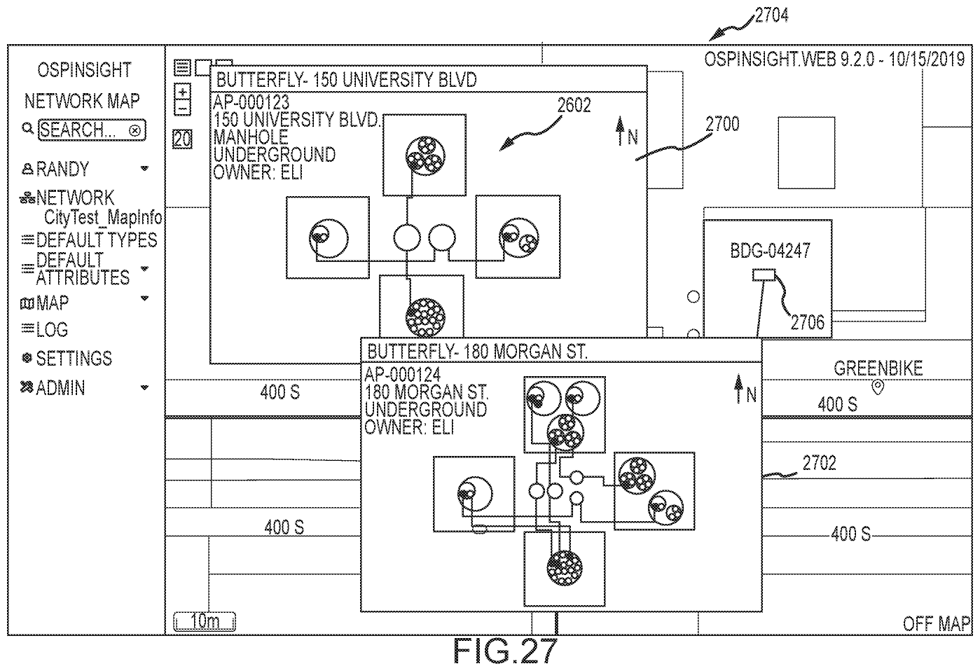

FIG. 27 shows that multiple windows 2700 and 2702 may be pulled up on the display 2704 to show detail of each access point 2706. For example, the windows 2700 and 2702 with associated detail may be opened by clicking on the desired access point 2706.

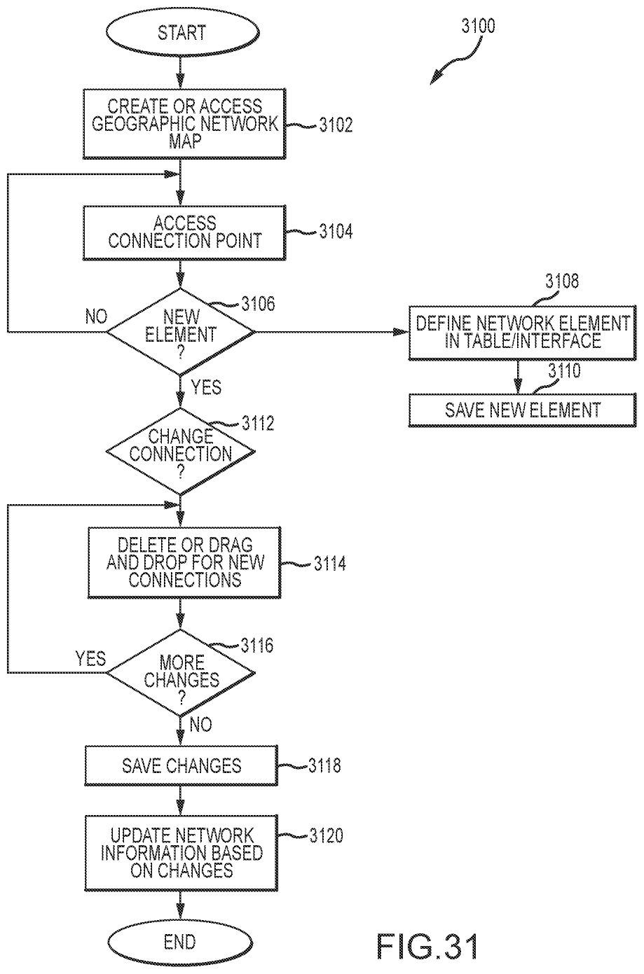

FIG. 31 illustrates a process 3100 that summarizes the operation of the third embodiment of the invention. The illustrated process 3100 is initiated by creating (3102) or accessing a geographic network map. In the case of changes to an existing fiber-optic network, an existing map may be pulled up and the user can click on a graphical representation of a connection point, such as a manhole, of interest. In the case of a new fiber-optic network, a geographical map corresponding to the area of the proposed fiber-optic network may be pulled up. Then, the user may begin defining the network by clicking on a location of interest and entering attribute information to begin defining fiber-optic elements of the network. In either case, the user can then access (3104) a desired connection point, for example, by clicking on the connection point.

A determination (3106) can then be made as to whether to define a new element at the connection point. If a new element is desired, the network element may be defined (3108) by populating a table defining the network element or otherwise entering element information via a user interface. Once the definition is complete, the new element may be saved (3110) and the network information database will be updated accordingly.

Next, a determination (3112) is made concerning whether changes are required to connections at the connection point. If no changes are desired, the process 3100 awaits the next access to the connection point. If changes are desired, the user may delete (3114) a connection or execute a drag-and-drop operation to form a new connection. To delete a connection, the user may right click on the connection and select “delete” from a drop-down menu. To form a new connection, the user may perform a drag-and-drop operation to connect to duct elements.

A determination (3116) may then be made concerning whether more changes are desired. If more changes are desired, step 3114 may be repeated. Otherwise, the changes may be saved (3118). In this regard, changes may be saved continuously and automatically as they are entered or may be saved when requested by the user. In either case, the network information is updated (3120) to reflect the changes.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims. It is the express intention of the applicant not to invoke 35 U.S.C. § 112(f) for any limitations of any of the claims herein, except for those in which the claim expressly uses the words ‘means for’ together with an associated function.

What is claimed:

1. A method for use in managing a fiber-optic network, comprising:
establishing a computer-based visualization tool for visualizing a fiber-optic network comprised of fiber-optic elements, said fiber-optic elements including multiple fiber-optic cables, wherein at least some of said fiber-optic cables include multiple fiber-optic tubes and at least some of said fiber-optic tubes include multiple optical fibers, said fiber-optic cables, fiber-optic tubes and optical fibers each defining a level of a fiber-optic hierarchy;
first operating said computer-based visualization tool to obtain configuration information concerning a configuration of said fiber-optic network, said configuration information including connection information regarding connections of fiber-optic elements at a connection point;
second operating said computer-based visualization tool to generate a display showing said connections of said fiber-optic elements at said connection point based on said configuration information;
third operating a user interface device in relation to said display to indicate a change in relation to said connections at said connection point; and
updating said configuration information based on said indicated change.

2. The method of claim 1, wherein said change comprises making an alteration of said configuration of said network by one of making a new connection and breaking an existing connection between two fiber-optic elements of a same level of said hierarchy at said connection point.

3. The method of claim 2, wherein said making an alteration comprises using said user interface device to identify a first fiber-optic element and a second fiber-optic element for one of making and breaking a connection.

4. The method of claim 2, further comprising reflecting said alteration in said display.

5. The method of claim 2, wherein said making an alteration comprises using said user interface device to splice a new fiber-optic element into an existing connection.

6. The method of claim 2, wherein said making an alteration comprises using said user interface device to establish a split from an existing connection.

7. The method of claim 2, wherein said making an alteration comprises propagating said alteration through said fiber-optic hierarchy.

8. The method of claim 7, wherein said making an alteration comprises one of making a new connection and breaking an existing connection between first and second higher order fiber-optic elements, each of said first and second higher order fiber-optic elements comprising one of a fiber-optic tube and a fiber-optic cable, and said propagating comprises establishing a new association to at least one of said first and second higher order fiber-optic elements for at least one optical fiber.

9. The method of claim 7, wherein said making an alteration comprises one of making a new connection and breaking an existing connection between first and second optical fibers, and said propagating comprises establishing a new association between at least one of said first and second optical fibers and at least one of an optical tube and an optical cable.

10. The method of claim 1, further comprising using said user interface device for identifying a portion of said display and, in response to said identifying, providing a view, within said display, of network configuration information related to said identified portion of said display.

11. The method of claim 1, further comprising operating said user interface device for moving one of a fiber-optic tube and a fiber-optic cable relative to said display and generating revised connections between optical fibers on said display responsive to said moving.

12. A system for use in managing a fiber-optic network, comprising:
a computer-based visualization tool for visualizing a fiber-optic network comprised of fiber-optic elements, said fiber-optic elements including multiple fiber-optic cables, wherein at least some of said fiber-optic cables include multiple fiber-optic tubes and at least some of said fiber-optic tubes include multiple optical fibers, said fiber-optic cables, fiber-optic tubes and optical fibers each defining a level of a fiber-optic hierarchy;
a storage module for storing said configuration information including connection information regarding connections of fiber-optic elements at a connection point;
wherein said computer-based visualization tool is operative to obtain said configuration information concerning said configuration of said fiber-optic network and generate a display showing said connections of said fiber-optic elements at said connection point based on said configuration information; and
a user interface operative in relation to said display to indicate a change in relation to said connections at said connection point, wherein said computer-based visualization tool updates said configuration information based on said indicated change.

13. The system of claim 12, wherein said user interface is operative for making an alteration of said configuration of said network by one of making a new connection and breaking an existing connection between two fiber-optic elements of a same level of said hierarchy at said connection point.

14. The system of claim 13, wherein said user interface is operative for making said alteration by using said user interface device to identify a first fiber-optic element and a second fiber-optic element for one of making and breaking a connection.

15. The system of claim 13, wherein said display is operative for reflecting said alteration.

16. The system of claim 13, wherein said user interface is operative in relation to said display to establish a splice of a new fiber-optic element into an existing connection.

17. The system of claim 13, wherein said user interface is operative in relation to said display to establish a split from an existing connection.

18. The system of claim 13, wherein said computer-based visualization tool is operative for propagating said alteration through said fiber-optic hierarchy.

19. The system of claim 18, wherein said alteration comprises one of making a new connection and breaking an existing connection between first and second higher order fiber-optic elements, each of said first and second higher order fiber-optic elements comprising one of a fiber-optic tube and a fiber-optic cable, and said computer-based visualization tool is operative for establishing a new association to at least one of said first and second higher order fiber-optic elements for at least one optical fiber.

20. The system of claim 18, wherein said alteration comprises one of making a new connection and breaking an existing connection between first and second optical fibers, and said computer-based visualization tool is operative for establishing a new association between at least one of said first and second optical fibers and at least one of an optical tube and an optical cable.

21. The system of claim 12, wherein said user interface is operative for identifying a portion of said display and said computer-based visualization tool is operative for, in response to said identifying, providing a view, within said display, of network configuration information related to said identified portion of said display.

22. The system of claim 12, wherein said user interface is operative for moving one of a fiber-optic tube and a fiber-optic cable relative to said display and said computer-based visualization tool is operative for generating revised connections between optical fibers on said display responsive to said moving.

23. A method for use in managing a fiber-optic network, comprising:
establishing a computer-based visualization tool for visualizing a fiber-optic network, said network including at least first and second patch panels for making connections between fiber-optic elements, each of said patch panels including multiple ports for receiving terminals of said fiber-optic elements;
entering, into said computer-based visualization tool, attribute information for at least first and second patch panels;
first operating said computer-based visualization tool to generate a display including said first and second patch panels based, at least in part, on said attribute information;
second operating a user interface device in relation to said display to indicate a change in relation to connections involving said first and second patch panels; and
third operating said computer-based visualization tool to generate an updated display showing said change.

24. A system for use in managing a fiber-optic network, comprising:
a computer-based visualization tool for visualizing a fiber-optic network, said network including at least first and second patch panels for making connections between fiber-optic elements, each of said patch panels including multiple ports for receiving terminals of said fiber-optic elements;
entering, into said computer-based visualization tool, attribute information for at least first and second patch panels;
said computer-based visualization tool being operative to generate a display including said first and second patch panels based, at least in part, on said attribute information; and
a user interface operative in relation to said display to indicate a change in relation to connections involving said first and second patch panels, wherein said computer-based visualization tool is operative to generate an updated display showing said change.

25. A method for use in managing a fiber-optic network, comprising:
establishing a computer-based visualization tool for visualizing a fiber-optic network, said fiber-optic network including a number of connection points distributed over a geographic area;
entering, into said computer-based visualization tool, attribute information for at least first and second fiber-optic cables that meet at a first connection point;
first operating said computer-based visualization tool to generate a graphical representation of said first connection point including said first and second fiber-optic cables; and
overlaying said graphical representation on a display of a map of said geographical area.

26. The method of claim 25, further comprising second operating a user input device in relation to said display to indicate a change in relation to connections at said first connection point.

27. A system for use in managing a fiber-optic network, comprising:
a computer-based visualization tool operative for visualizing a fiber-optic network, said fiber-optic network including a number of connection points distributed over a geographic area;
a user interface operative for entering, into said computer-based visualization tool, attribute information for at least first and second fiber-optic cables that meet at a first connection point;
said computer-based visualization tool being operative for generating a graphical representation of said first connection point including said first and second fiber-optic cables and overlaying said graphical representation on a display of a map of said geographical area.

28. The system of claim 27, further comprising a user input module operative in relation to said display to indicate a change in relation to connections at said first connection point.
